(19) United States
(12) Patent Application Publication
(10) Pub. No.: US 2025/0286614 A1
(43) Pub. Date: Sep. 11, 2025

(54) METHOD AND APPARATUS FOR DISCOVERING LOW LATENCY LINK IN NON-TERRESTRIAL NETWORK

(71) Applicants: Hyundai Motor Company, Seoul (KR); Kia Corporation, Seoul (KR)

(72) Inventors: Young Kil Suh, Hwaseong, Gyeonggi-do (KR); Ui Hyun Hong, Hwaseong, Gyeonggi-do (KR); Gene Back Hahn, Hwaseong, Gyeonggi-do (KR); Hyun Jin Kim, Hwaseong, Gyeonggi-do (KR)

(21) Appl. No.: 18/859,539

(22) PCT Filed: Apr. 21, 2023
(86) PCT No.: PCT/KR2023/005486

§ 371 Date: Oct. 23, 2024

(30) Foreign Application Priority Data
Apr. 26, 2022 (KR) 10-2022-0051546

(51) Int. Cl. H04B 7/185

(52) U.S. Cl. CPC H04B 7/18539; H04B 7/18513; H04B 7/18591

(57) ABSTRACT

The present disclosure discloses a method and apparatus for discovering a low latency link in a non-terrestrial network (NTN). The method for a first base station according to an embodiment of the present disclosure may comprise the steps of: if a second non-terrestrial network (NTN) link is established to a terminal via a second satellite while a first NTN link is established with the terminal via a first satellite, establishing the first NTN link as a temporary low latency link; acquiring first low latency link-related information for nodes of the first NTN link; acquiring second low latency link-related information for nodes of the second NTN link; determining a low latency link on the basis of the first low latency link-related information and the second low latency link-related information; and transmitting information of the determined low latency link to the terminal.

### TECHNICAL FIELD

The present disclosure relates to a non-terrestrial network (NTN) technique, and more particularly, to a technique for discovering a low latency link in an NTN.

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, in an environment where multiple base stations on the ground and multiple satellites, which are capable of serving a terminal, exist, the terminal can receive data from some of the multiple base stations through a multi-transmission/reception point (multi-TRP) or multi-connectivity technique. In particular, when utilizing a satellite (e.g. bent-pipe type), a transmission latency between the terminal and the base station is determined by a location (e.g. altitude, elevation angle, etc.) of a satellite, location of the terminal, and location of a gateway on the ground. The latencies of links providing multi-connectivity services may vary greatly, ranging from a few milliseconds (ms) to several hundred milliseconds (ms). In such cases, there may be situations where utilizing a low latency link appropriately in the multi-link (or multi-TRP) environment can provide benefits. For instance, if all hybrid automatic repeat request (HARQ) feedbacks for data (e.g. PDSCHs) received through multiple links are transmitted through the low latency link, congestion caused by HARQ feedback delays can be reduced. Methods for discovering the low latency link are needed to implement such techniques.

### DISCLOSURE

### Technical Problem

The present disclosure for resolving the above-described problems is directed to providing a method and an apparatus for discovering and operating a low latency link in a multi-connectivity environment of a non-terrestrial network (NTN).

### Technical Solution

A method of a first base station, according to exemplary embodiments of the present disclosure for achieving the above-described objective, may comprise: in response to a second non-terrestrial network (NTN) link being established with a terminal through a second satellite while a first NTN link is established with the terminal through a first satellite, configuring the first NTN link as a temporary low latency link; obtaining first low latency link-related information for nodes of the first NTN link; obtaining second low latency link-related information for nodes of the second NTN link; determining a low latency link based on the first low latency link-related information and the second low latency link-related information; and transmitting information on the determined low latency link to the terminal.

The nodes of the first NTN link may include: a first gateway directly connected to the first base station; the first satellite connected to the first gateway through a first feeder link; and the terminal connected to the first satellite through a first service link.

The nodes of the second NTN link may include: a second base station; a second gateway directly connected to the second base station; a second satellite connected to the second gateway through a second feeder link, and the terminal connected to the second satellite through a second service link.

The method may further comprise: transmitting information on the low latency link to the second base station.

The method may further comprise: requesting second NTN link state information from the second base station; and receiving the second NTN link state information from the second base station, wherein the second NTN link state information includes information on whether the terminal has performed a random access procedure.

The nodes of the second NTN link may include: the first gateway directly connected to the first base station; a second satellite connected to the first gateway through a second feeder link, and the terminal connected to the second satellite through a second service link.

The first low latency link-related information for the first NTN link may include at least one of location information of the nodes of the first NTN link or information on delays between the nodes of the first NTN link, and the second low latency link-related information for the second NTN link may include at least one of location information of the nodes of the second NTN link or information on delays between the nodes of the second NTN link.

The method may further comprise: re-determining the low latency link when periodic location or delay information is received from the terminal.

The determining of the low latency link may comprise: obtaining a first propagation delay of an NTN link having a minimum latency among NTN links that are not a current low latency link; calculating a difference between a second propagation delay of the current low latency link and the first propagation delay; and in response to the difference greater than a predetermined value, determining the NTN link having the first propagation delay as the low latency link.

A method of a first base station, according to exemplary embodiments of the present disclosure for achieving the above-described objective, may comprise: establishing a first non-terrestrial network (NTN) link with a terminal through a first satellite; receiving a request for low latency link-related information from a second base station of a second NTN link already established with the terminal before establishing the first NTN link; transmitting low latency link-related information of the first NTN link to the second base station according to the request; in response to receiving information on a low latency link configured as an NTN link of the first base station from the second base station, obtaining low latency link-related information of all NTN links established with the terminal according to a preset time interval; determining a low latency link based on the obtained low latency link-related information of all NTN links; and transmitting information on the determined low latency link to the terminal.

The nodes of the first NTN link may include: a first gateway directly connected to the first base station; a first satellite connected to the first gateway through a first feeder link; and the terminal connected to the first satellite through a first service link.

The nodes of the second NTN link may include: a second base station; a second gateway directly connected to the second base station; a second satellite connected to the second gateway through a second feeder link, and the terminal connected to the second satellite through a second service link.

The method may further comprise: after establishing the first NTN link, receiving, from the second base station, a request for first NTN link state information including information on whether the terminal has performed a random access procedure; and transmitting the first NTN link state information to the second base station according to the request.

The low latency link-related information for the first NTN link may include at least one of location information of the nodes of the first NTN link or information on delays between the nodes of the first NTN link, and the low latency link-related information for the second NTN link may include at least one of location information of the nodes of the second NTN link or information on delays between the nodes of the second NTN link.

The method may further comprise: re-determining the low latency link when periodic location or delay information is received from the terminal.

The determining of the low latency link may comprise: obtaining a propagation delay of an NTN link having a minimum latency among NTN links that are not a current low latency link; calculating a difference between a propagation delay of the current low latency link and the propagation delay of the NTN link having the minimum delay; and in response to the difference greater than a predetermined value, determining the NTN link having the minimum latency as the low latency link.

A first base station, according to exemplary embodiments of the present disclosure for achieving the above-described objective, may comprise a processor, and the processor may cause the first base station to perform: in response to a second non-terrestrial network (NTN) link being established with a terminal through a second satellite while a first NTN link is established with the terminal through a first satellite, configuring the first NTN link as a temporary low latency link; obtaining first low latency link-related information for nodes of the first NTN link; obtaining second low latency link-related information for nodes of the second NTN link; determining a low latency link based on the first low latency link-related information and the second low latency link-related information; and transmitting information on the determined low latency link to the terminal.

The processor may further cause the first base station to perform: transmitting information on the low latency link to the second base station.

The processor may further cause the first base station to perform: requesting second NTN link state information from the second base station; and receiving the second NTN link state information from the second base station, wherein the second NTN link state information may include information on whether the terminal has performed a random access procedure.

The first low latency link-related information for the first NTN link may include at least one of location information of the nodes of the first NTN link or information on delays between the nodes of the first NTN link, and the second low latency link-related information for the second NTN link may include at least one of location information of the nodes of the second NTN link or information on delays between the nodes of the second NTN link.

### Advantageous Effects

According to the present disclosure, there are advantages of discovering a low latency link in a non-terrestrial network's multi-connectivity environment and efficiently operating the discovered low latency link.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8 is a conceptual diagram illustrating a plurality of satellites and base stations corresponding thereto for providing a multi-connectivity service to one terminal to describe an exemplary embodiment of the present disclosure.

FIG. 9 is a conceptual diagram illustrating a plurality of satellites for providing a multi-connectivity service to one terminal and a case where the plurality of satellites are connected to one base station to describe another exemplary embodiment of the present disclosure.

FIG. 10A is a part of a signal flow diagram illustrating a low latency link discovery method using location information of a terminal and base stations according to an exemplary embodiment of the present disclosure.

FIG. 10B is the remaining part of the signal flow diagram illustrating a low latency link discovery method using location information of a terminal and base stations according to an exemplary embodiment of the present disclosure.

FIG. 11A is a part of a signal flow diagram illustrating a low latency link discovery method using location information of a terminal and base stations according to another exemplary embodiment of the present disclosure.

FIG. 11B is the remaining part of the signal flow diagram illustrating a low latency link discovery method using location information of a terminal and base stations according to another exemplary embodiment of the present disclosure.

FIG. 12 is a flowchart of an operation of an NTN according to a first exemplary embodiment of the present disclosure.

FIG. 13 is a flowchart of operations of an NTN according to a second exemplary embodiment of the present disclosure.

FIG. 14 is a flowchart of operations of an NTN according to a third exemplary embodiment of the present disclosure.

FIG. 15 is a flowchart of operations of an NTN according to a fourth exemplary embodiment of the present disclosure.

### MODE FOR INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re) transmission” may refer to “transmission”, “retransmission”, or “transmission and retransmission”, “(re) configuration” may refer to “configuration”, “reconfiguration”, or “configuration and reconfiguration”, “(re) connection” may refer to “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

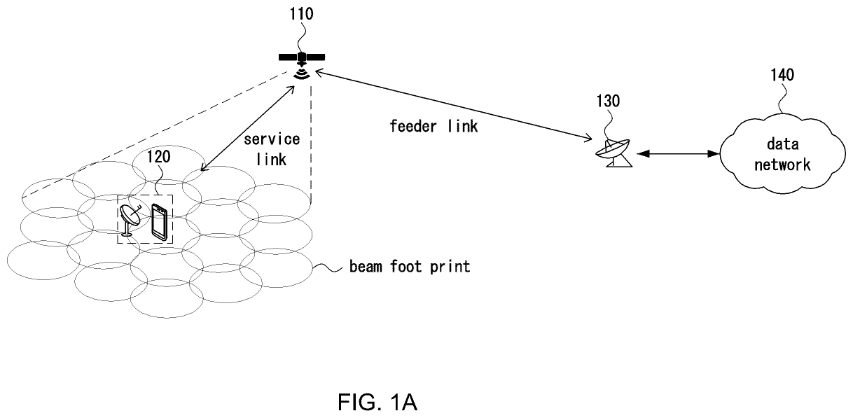

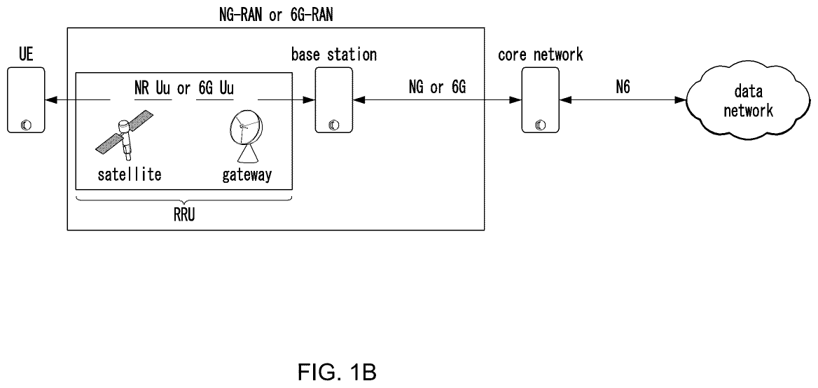

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

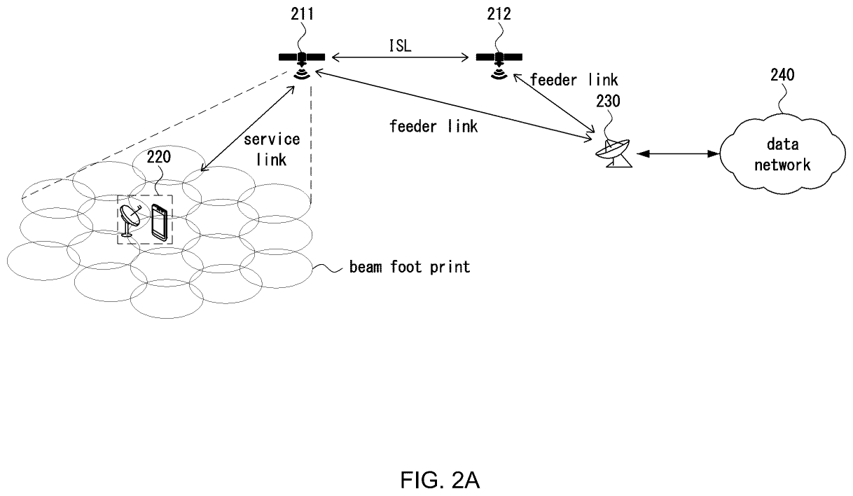

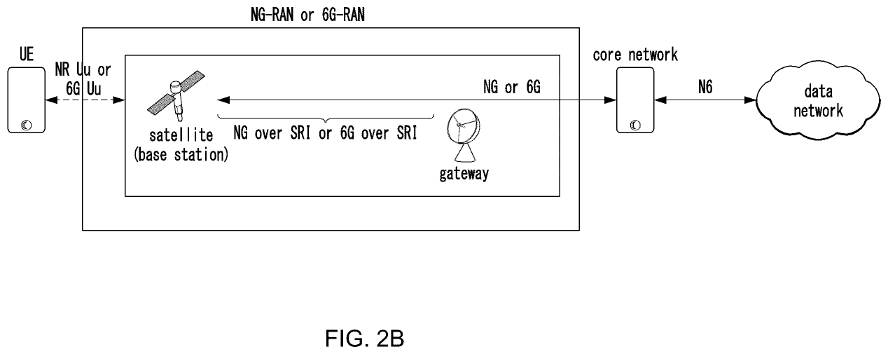

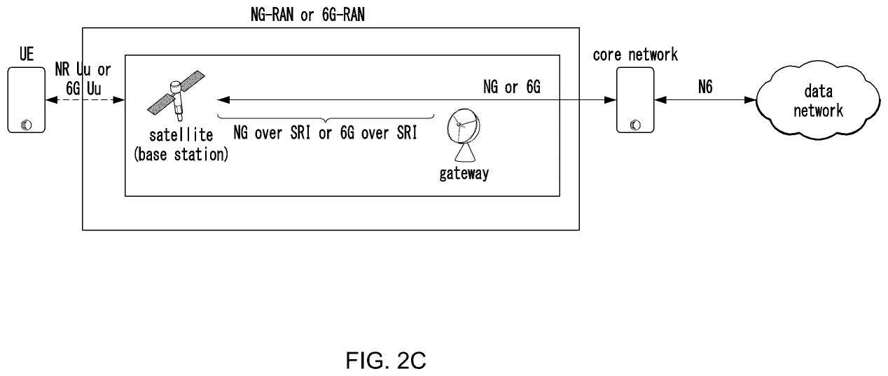

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

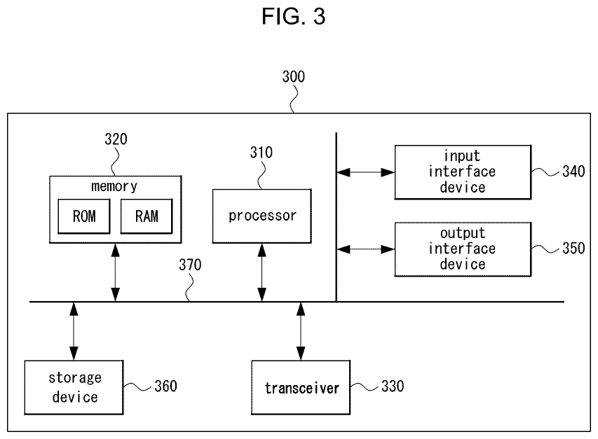

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

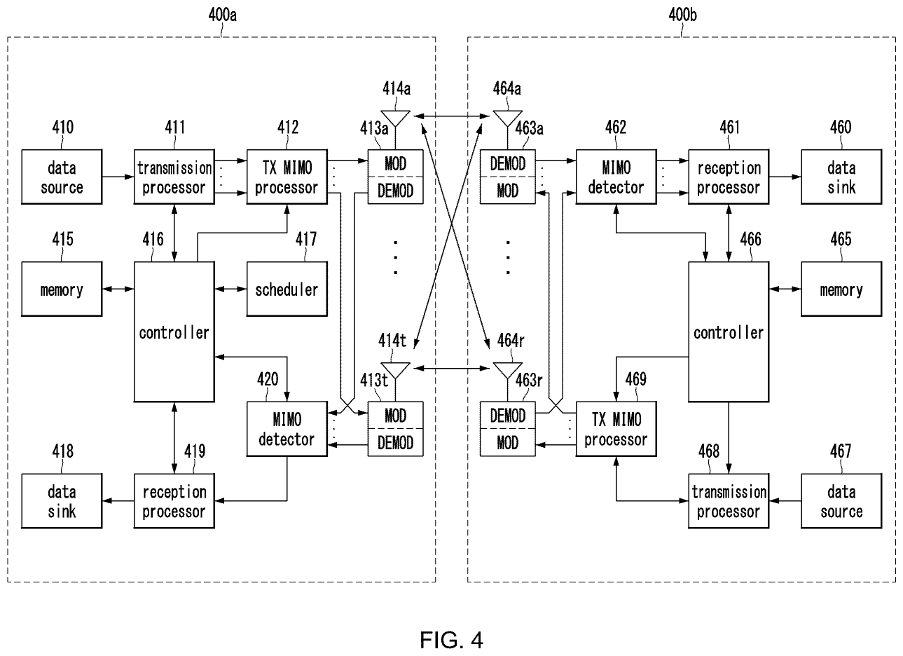

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

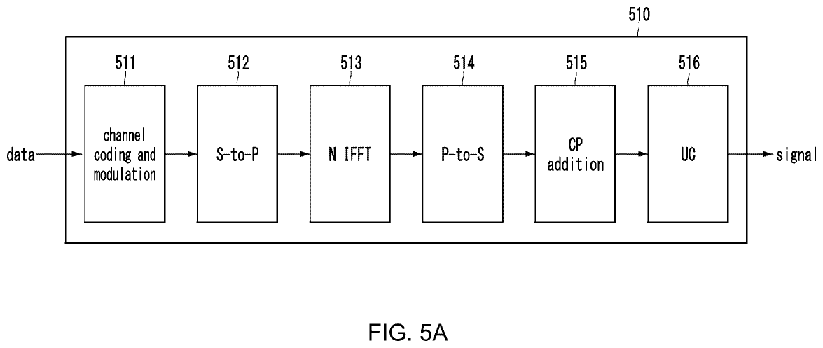

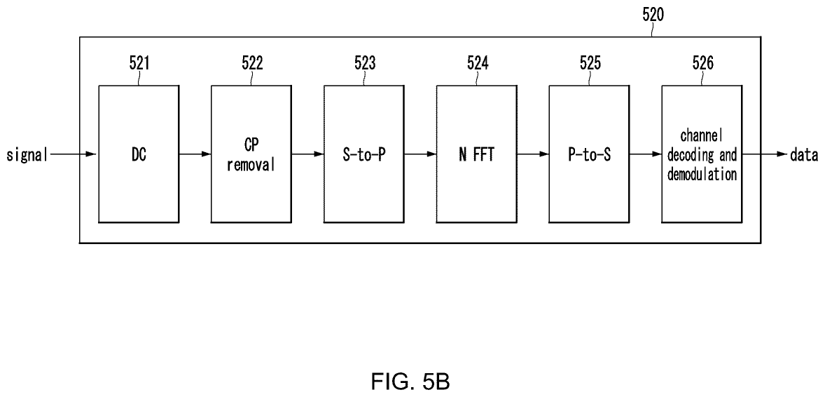

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’.

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |

| | |
|---|---|
| 1,200 | km |

| Spectrum (service | <6 GHz (e.g. 2 GHz) | | |
|---|---|---|---|
| link) | >6 GHz (e.g. DL 20 GHz, UL 30 GHz) | | |
| Maximum channel | 30 MHz for band <6 GHz | | |
| bandwidth capability | 1 GHz for band >6 GHz | | |
| (service link) | | | |
| Maximum distance | 40,581 | km | 1,932 km (altitude of |
| between satellite and | | | 600 km) |
| communication node (e.g. | | | 3,131 km (altitude of |
| UE) at the minimum | | | 1,200 km) |
| elevation angle | | | |
| Maximum round trip | Scenario A: 541.46 | | Scenario C: |
| delay (RTD) | ms (service and feeder | | (transparent payload: service |
| (only propagation | links) | | and feeder links) |
| delay) | Scenario B: 270.73 | | −5.77 ms (altitude of |
| | ms (only service link) | | 60 0 km) |
| | | | −41.77 ms (altitude of |
| | | | 1,200 km) |
| | | | Scenario D: |
| | | | (regenerative payload: only |
| | | | service link) |
| | | | −12.89 ms (altitude of |
| | | | 600 km) |
| | | | −20.89 ms (altitude of |
| | | | 1,200 km) |
| Maximum | 10.3 | ms | 3.12 ms (altitude of |

| | |
|---|---|
| differential delay within a | 600 km) |
| cell | 3.18 ms (altitude of |
| | 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | | Scenario C1-2 | | Scenario D1-2 | |
|---|---|---|---|---|---|---|---|
| Satellite altitude | 35,786 km | | | 600 km | | | |
| Maximum RTD in a | 541.75 ms | 270.57 | ms | 28.41 | ms | 12.88 | ms |
| radio interface between | (worst case) | | | | | | |
| base station and UE | | | | | | | |
| Minimum RTD in a | 477.14 ms | 238.57 | ms | 8 | ms | 4 | ms |

radio interface between
base station and UE

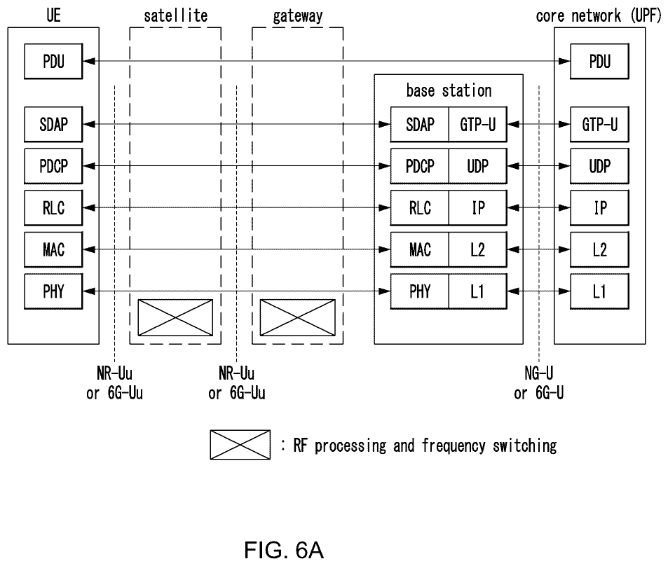

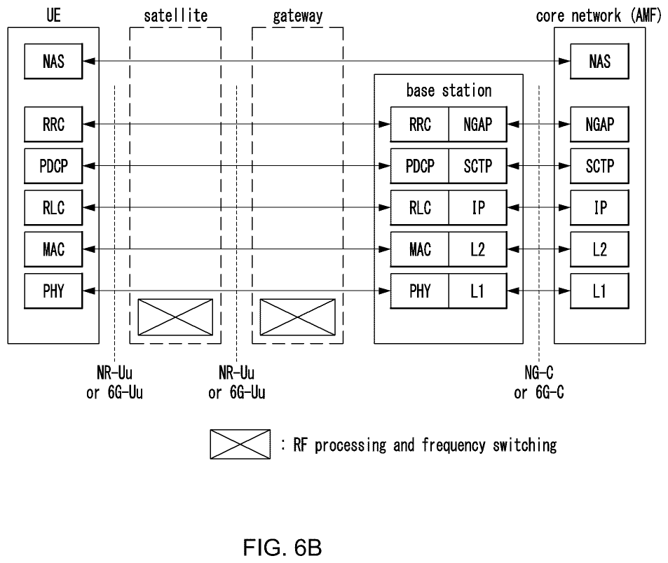

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network. As shown in FIGS. 6A and 6B, user data may be transmitted and received between a UE and a core network (e.g. UPF), and control data (e.g. control information) may be transmitted and received between the UE and the core network (e.g. AMF). Each of the user data and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

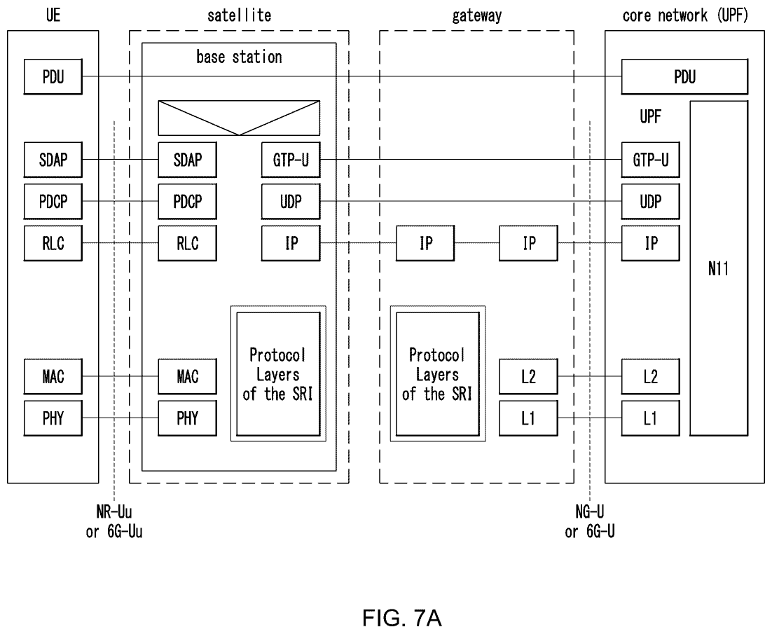

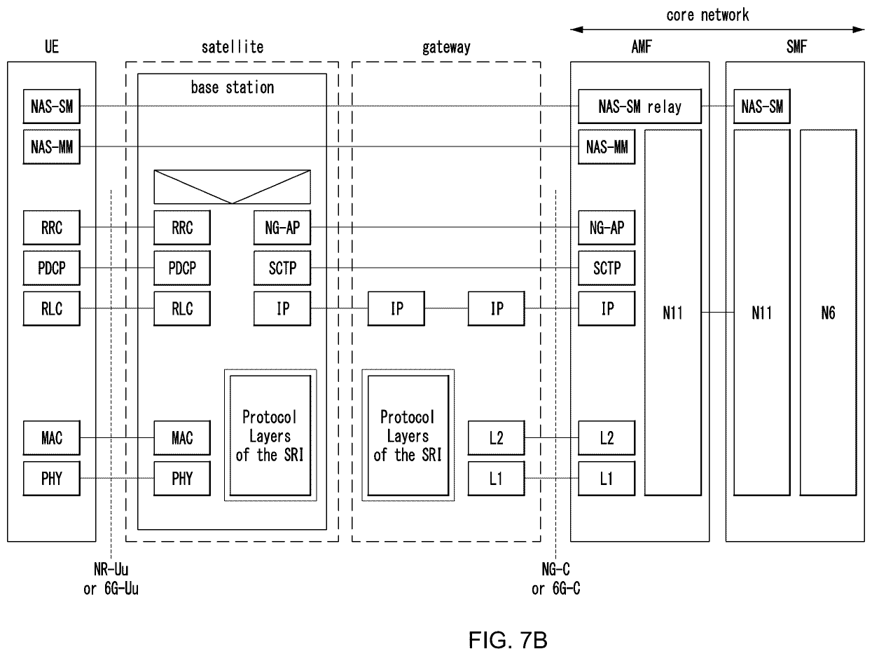

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, in a non-terrestrial network, a base station may transmit system information (e.g. SIB19) including satellite assistance information for NTN access. A UE may receive the system information (e.g. SIB19) from the base station, identify the satellite assistance information included in the system information, and perform communication (e.g. non-terrestrial communication) based on the satellite assistance information. The SIB19 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE (SIZE(1..maxCellNTN-r17)) |

OF NTN-NeighCellConfig-r17

| | |
|---|---|
| NTN-NeighCellConfig-r17 ::= | SEQUENCE { |
| ntn-Config-r17 | NTN-Config-r17 |
| carrierFreq-r17 | ARFCN-ValueNR |
| physCellId-r17 | PhysCellId |

}

NTN-Config defined in Table 4 may include information element(s) defined in Table 5 below.

TABLE 5

| | |
|---|---|
| NTN-Config-r17 ::= | SEQUENCE { |
| epochTime-r17 | EpochTime-r17 |

ntn-UlSyncValidityDuration-r17 ENUMERATED{ s5, s10, s15, s20, s25, s30, s35,
s40, s45, s50, s55, s60, s120, s180, s240, s900}

| | |
|---|---|
| cellSpecificKoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |
| ta-CommonDriftVariant-r17 | INTEGER(0..28949) |

}

EphemerisInfo defined in Table 5 may include information element(s) defined in Table 6 below.

TABLE 6

| | |
|---|---|
| EphemerisInfo-r17 ::= | CHOICE { |
| positionVelocity-r17 | PositionVelocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

Meanwhile, a satellite may be largely classified into a transparent repeater and a regenerative repeater.

First, a satellite that operate as a transparent repeater may be referred to as a transparent satellite. The transparent satellite may only perform an operation of amplifying a received signal and forwarding the amplified signal to a destination. For example, when the transparent satellite receives an RF signal to be transmitted to a terminal from a gateway, it may only perform a role of amplifying the RF signal received from the gateway and transmitting the amplified RF signal to the terminal. The transparent satellite may perform not only downlink transmission to the terminal but also uplink transmission from the terminal in the same manner. For example, when the transparent satellite receives an RF signal from the terminal, it may only perform an operation of amplifying the received RF signal and transmitting the amplified signal to the gateway. Therefore, the transparent satellite does not demodulate the received signal and only performs a role of forwarding the received signal through downlink or uplink. Therefore, such transparent satellite may be referred to as a bent-pipe satellite.

The case where a satellite is implemented as a transparent repeater may correspond to the same configuration as the configuration of FIG. 1B described above. Describing this again with reference to FIG. 1B, the NTN may include a terminal, a transparent satellite orbiting a specific Earth orbit, an NTN gateway on the ground, and a base station on the ground. As previously illustrated in FIG. 1B, a link between the terminal and the satellite may refer to a service link, and a link between the transparent satellite and the NTN gateway may refer to a feeder link. The gateway may be included in the base station or may be a separate entity as illustrated in FIG. 1B.

In the NTN, the NTN gateway and satellite may be understood as a remote radio unit (RRU), as illustrated in FIG. 1B. In general, in the 3GPP communication system, a base station may be a subject of data transmission/reception and scheduling, and when the gateway and transparent satellite operate as an RRU, the RRU may be understood as performing a relay function between the base station and the terminal.

Hereinafter, a case where a satellite is implemented as a regenerative repeater will be described.

A satellite that operates as a regenerative repeater may be referred to as an on-board processing repeater or regenerative satellite. The regenerative satellite may demodulate a received RF signal, recover it to a baseband signal, remodulate and converting the recovered baseband signal into an RF signal, and transmit the RF signal. For example, when the regenerative satellite receives an RF signal to be transmitted to a terminal from a gateway, it may convert the received signal into a baseband signal and then demodulate the baseband signal. Then, the regenerative satellite may remodulate the demodulated signal to generate an RF signal to be transmitted through downlink, and transmit the RF signal to the terminal. The regenerative satellite may perform not only downlink transmission to the terminal but also uplink transmission from the terminal in the same manner. For example, when the regenerative satellite receives an RF signal from the terminal, it may demodulate the received RF signal, recover it to a baseband signal, remodulate and convert the recovered baseband signal into an RF signal, and transmit the RF signal to the gateway.

The case where a satellite is implemented as a regenerative repeater may correspond to the same configuration as the configuration of FIG. 2B described above.

As illustrated in FIG. 2B, the NTN may include a terminal, a regenerative satellite orbiting a specific Earth orbit, and an NTN gateway. In addition, FIG. 2B illustrates a form in which a base station is included in the satellite, but a base station may exist between the gateway and a core network. When a base station is located between the gateway and the core network, the base station may be a central unit (CU), and the satellite may be a distributed unit (DU). Therefore, the satellite may operate as a base station-DU (gNB-DU), and the base station may operate as a base station-CU (gNB-CU). The split into DU and CU may conform to one of schemes of configuring the 5G network, which are specified in the 3GPP technical specifications. Since an F1 interface is used between CU and DU, an F1 interface may be established between the base station and the satellite. In this case, since a connection between the satellite and the gateway is based on an SRI as described above, an F1 interface over SRI (i.e. F1 over SRI) may be used.

Describing the configuration of FIG. 2B as a whole based on the above description, it may include the regenerative satellite (gNB-DU) orbiting a specific Earth orbit, NTN gateway on the ground, and base station-CU (gNB-CU) on the ground. Even in this case, a link between the terminal and the satellite may refer to a service link. Since the satellite is a gNB-DU, it may perform data transmission/reception and scheduling.

As described above with reference to FIGS. 1B and 2B, a link of the transparent satellite may be divided into a service link and a feeder link. While the service link may have a different link length for each terminal, the feeder link may have the same length for all terminals communicating with the specific satellite. Therefore, in order to efficiently manage a propagation delay occurring in the NR NTN, timing information (i.e. propagation delay information) of the feeder link and timing information of the service link may be provided to the terminal, and through these information, a timing advance (TA) may be calculated as in Equation 1 below.

$${T}_{TA} = ( {N}_{TA} + {N}_{TA , offset} + {N}_{TA , UE - specific} + {N}_{TA , common} ) \times {T}_{c} \qquad [ Equation 1 ]$$

In Equation 1, N_{TA} may be the same as N_{TA} in the existing terrestrial network, and N_{TA}, UE-specific and N_{TA,common} are additionally defined for TA information in the NTN. Here, N_{TA,UE-specific} may be information on a UE-specific TA for each terminal, which is generated by a propagation delay occurring in the service link and/or feeder link, and N_{TA}, common may be information on a UE-common TA within one satellite, which is generated by a propagation delay occurring in the service link and/or feeder link. N_{TA,offset} may refer to a TA value to be applied in UE-common, and T_{c} is a basic time unit constant (i.e. (4096*480*1000)⁻¹ second) mainly used in the NR physical layer.

The present disclosure described below proposes methods for discovering the lowest latency link in a multi-connectivity environment. The present disclosure described below may be applied to both a network configuration using transparent satellite(s) and a network configuration using regenerative satellite(s). However, for convenience of description, description will be made based on transparent satellites in the present disclosure. However, the present disclosure described below may be applied in the same manner to regenerative satellites.

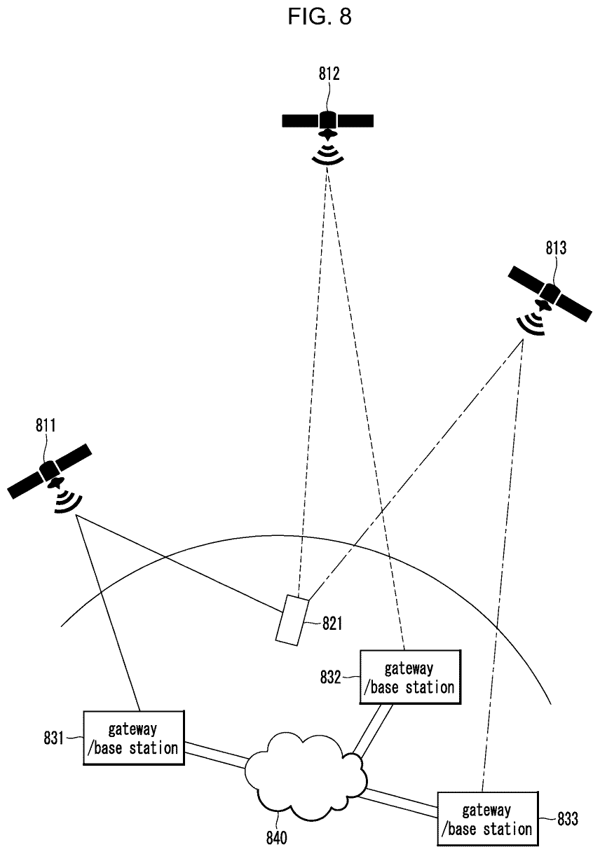

FIG. 8 is a conceptual diagram illustrating a plurality of satellites and base stations corresponding thereto for providing a multi-connectivity service to one terminal to describe an exemplary embodiment of the present disclosure.

As shown in FIG. 8, three different satellites 811, 812, and 813, terrestrial gateways/base stations 831, 832, and 833 respectively corresponding to the satellites 811 to 813, a terminal capable of communicating with each of the satellites 811 to 813, and a core network 840 to which the gateways/base stations 831 to 833 are connected are illustrated. The gateways/base stations 831 to 833 illustrated in FIG. 8 may each be implemented in a form where a base station and a gateway are connected, in a form where a base station includes a gateway, or in a form where a gateway includes a base station. In addition, FIG. 8 assumes a case where the terminal 821 does not establish a direct link with a base station.

In addition, the satellites 811 to 813 in FIG. 8 may be quasi-earth-fixed and/or earth-moving satellites rather than earth-fixed satellites in geostationary orbits. The satellites 811 to 813 illustrated in FIG. 8 will be described assuming that they are transparent satellites.

The first satellite 811 may be connected to the first gateway/base station 831 to communicate with the terminal 821, the second satellite 812 may be connected to the second gateway/base station 832 to communicate with the terminal 821, and the third satellite 813 may connected to the third gateway/base station 833 to communicate with the terminal 821. Since the first to third satellites 811 to 831 are not satellites located in geostationary orbits, as the satellites move, a gateway/base station on the ground, which is connected to each of the satellites 811 to 813, may vary depending on the movement of the satellites. Therefore, the connections between the satellites 811 to 813 and the gateways/base stations 831 to 833 illustrated in FIG. 8 may be connections at a specific time point.

According to the example of FIG. 8, the connection between the terminal 821 and the first gateway/base station 831 may include a first feeder link, which is a link between the first satellite 811 and the first gateway/base station 831, and a first service link between the first satellite 811 and the terminal 821. In addition, the connection between the terminal 821 and the second gateway/base station 832 may include a second feeder link, which is a link between the second satellite 812 and the second gateway/base station 832, and a second service link between the second satellite 812 and the terminal 821. The connection between the terminal 821 and the third gateway/base station 833 may include a third feeder link, which is a link between the third satellite 813 and the third gateway/base station 833, and a third service link between the third satellite 813 and the terminal 821.

As illustrated in FIG. 8, the distances of the feeder links between the satellites 811 to 813 and gateways/base stations 831 to 833 and the service links between the satellites 811 to 813 and the terminal 821 may be determined depending on the altitudes or elevation angles of the satellites, locations of the base stations, and location of the terminal. Further, the shortest distance (e.g. Line of Sight (LOS) distance) of each feeder link and the shortest distance (e.g. LOS distance) of each service link may also be determined based thereon. In other words, the shortest distances of the feeder links and the shortest distances of the service links may vary depending on the altitudes or elevation angles of the satellites, locations of the base stations, and location of the terminal.

The differences in the distances of feeder links and the distances of service links will be described using the satellites 811 to 813 illustrated in FIG. 8 as an example.

As shown in FIG. 8, a feeder link having the shortest distance among the feeder links may be the first feeder link, and a feeder link having the longest distance among the feeder links may be the second feeder link. A service link having the shortest distance among the service links may be the first service link, and a service link having the longest distance among the service links may be the third service link. Therefore, the second feeder link may be longer than the first feeder link and shorter than the third feeder link, and the second service link may also be longer than the first service link and shorter than the third service link.

The present disclosure provides methods for the terminal 821 and/or the base stations 831 to 833 to discover a low latency link with respect to the terminal 821 capable of multi-connectivity. In addition, the present disclosure provides methods for managing the discovered low latency link.

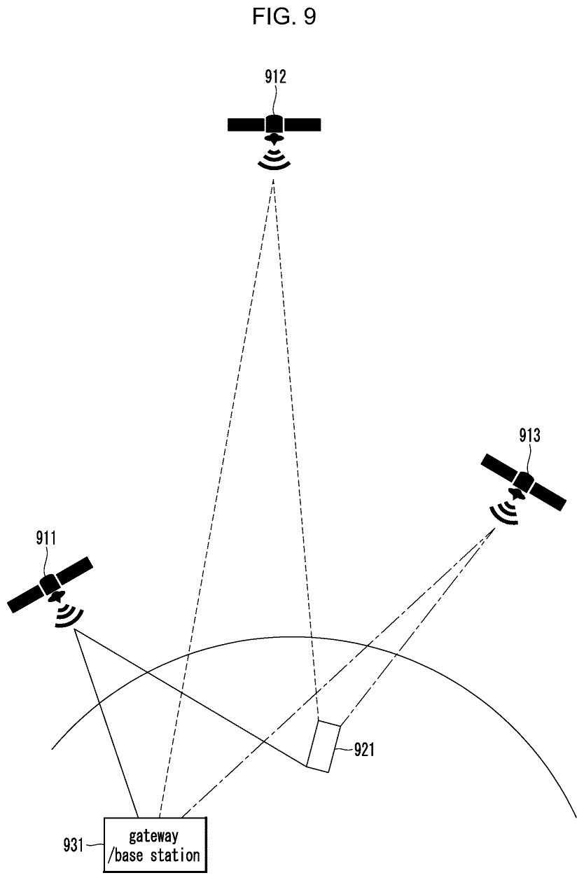

FIG. 9 is a conceptual diagram illustrating a plurality of satellites for providing a multi-connectivity service to one terminal and a case where the plurality of satellites are connected to one base station to describe another exemplary embodiment of the present disclosure.

As shown in FIG. 9, three different satellites 911, 912, and 913, one gateway/base station 931 connected to the satellites 911 to 913, and a terminal 921 capable of communicating with each of the satellites 911 to 913 are illustrated. The gateway/base station 931 illustrated in FIG. 9 may be implemented in a form where a base station and a gateway are connected, in a form where a base station includes a gateway, or in a form where a gateway includes a base station. In addition, FIG. 9 assumes a case where the terminal 921 does not establish a direct link with the base station 931.

In addition, the satellites 911 to 913 in FIG. 9 may be quasi-earth-fixed and/or earth-moving satellites rather than earth-fixed satellites in geostationary orbits. The satellites 911 to 913 illustrated in FIG. 9 will be described assuming that they are transparent satellites.

The first satellite 911 may be connected to the gateway/base station 931 to communicate with the terminal 921, the second satellite 912 may be connected to the gateway/base station 931 to communicate with the terminal 921, and the third satellite 913 may connected to the gateway/base station 931 to communicate with the terminal 921. Since the first to third satellites 911 to 913 are not satellites located in geostationary orbits, as the satellites move, distances between the satellites 911 to 913 and the gateway/base station 931 may vary according to the movement of the satellites 911 to 913.

According to the example of FIG. 9, the connection between the terminal 921 and the gateway/base station 931 may include a first feeder link, which is a link between the first satellite 911 and the gateway/base station 931, and a first service link between the first satellite 911 and the terminal 921. In addition, the connection between the terminal 921 and the gateway/base station 931 may include a second feeder link, which is a link between the second satellite 912 and the gateway/base station 931, and a second service link between the second satellite 912 and the terminal 921. The connection between the terminal 921 and the gateway/base station 931 may include a third feeder link, which is a link between the third satellite 913 and the gateway/base station 931, and a third service link between the third satellite 913 and the terminal 921.

As illustrated in FIG. 9, the distances of the feeder links between the satellites 911 to 913 and the gateway/base station 931 and the service links between the satellites 911 to 913 and the terminal 921 may be determined depending on the altitudes or elevation angles of the satellites, location of the base station, and location of the terminal. Further, the shortest distance (e.g. LOS distance) of each feeder link and the shortest distance (e.g. LOS distance) of each service link may also be determined based thereon. In other words, the shortest distances of the feeder links and the shortest distances of the service links may vary depending on the altitudes or elevation angles of the satellites, location of the base station, and location of the terminal.

The differences in the distances of feeder links and the distances of service links will be described using the satellites 911 to 913 illustrated in FIG. 9 as an example.

As shown in FIG. 9, a feeder link having the shortest distance among the feeder links may be the first feeder link, and a feeder link having the longest distance among the feeder links may be the second feeder link. A service link having the shortest distance among the service links may be the first service link, and a service link having the longest distance among the service links may be the third service link. Therefore, the second feeder link may be longer than the first feeder link and shorter than the third feeder link, and the second service link may also be longer than the first service link and shorter than the third service link.

The example of FIG. 9 may correspond to a multi-TRP environment because the multiple satellites 911 to 913 are connected to one base station. In addition, in the case of FIG. 9, although all satellites 911 to 913 are connected to the same gateway/base station 931, the lengths of the service links and the lengths of the feeder links may vary depending on the locations of the satellites.

Therefore, the present disclosure provides methods for the terminal 921 and/or the base stations to discover a low latency link with respect to the terminal 921 capable of multi-connectivity. In addition, the present disclosure provides methods for operating the discovered low latency link.

In the present disclosure below, a link with a low latency among multiple links toward a multi-connectivity-capable terminal in the NTN environment may be referred to as a low latency link (QuickLink), and methods for discovering the QuickLink are proposed. Although a satellite with the lowest latency may be simply considered as a satellite orbiting at the lowest altitude, the length of the link may vary depending on a location of the terminal on the service link or a location of the gateway/base station on the feeder link. Therefore, it is not possible to specify a satellite with the lowest latency based solely on the altitude of the satellite, and a satellite with the lowest latency needs to be discovered through a more complicated procedure.

### First Exemplary Embodiment: Low Latency Link Discovery Using Location Information

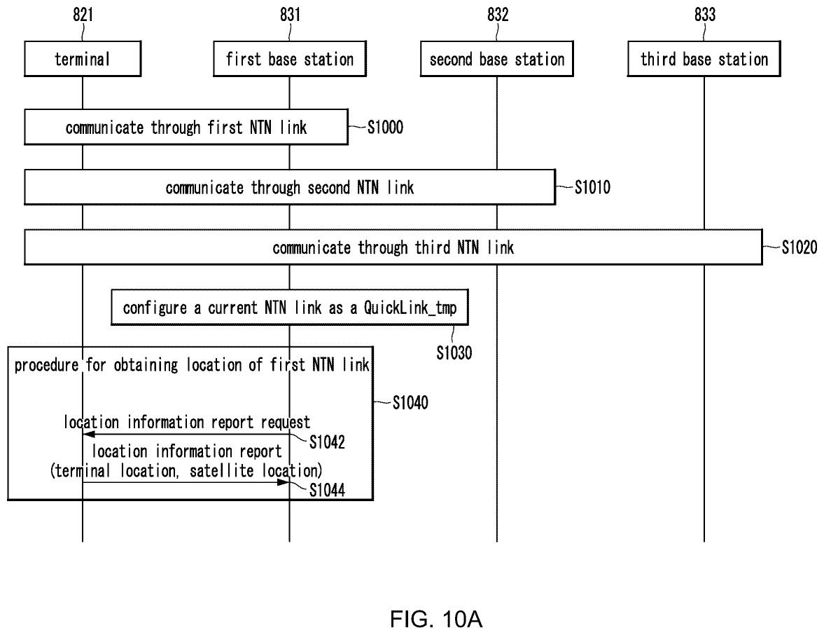

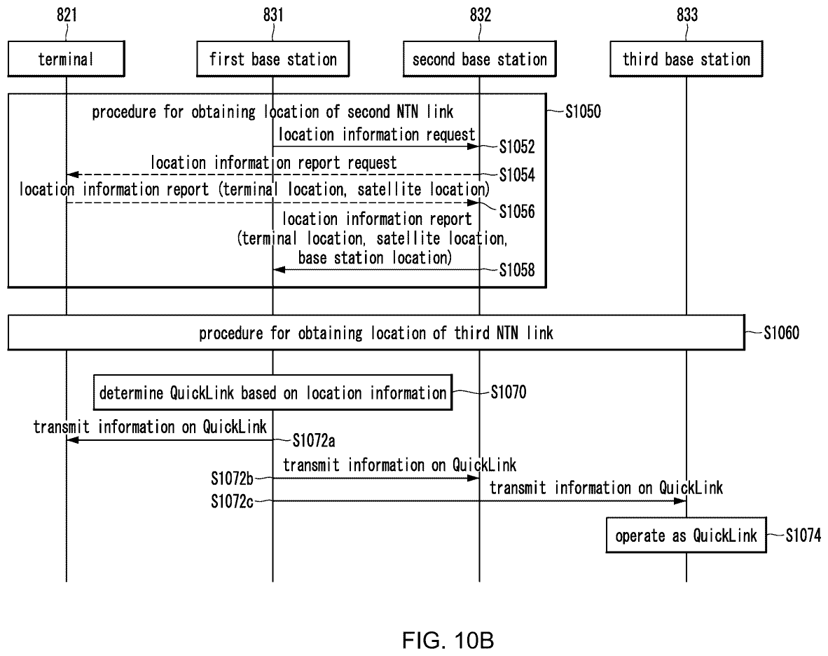

FIG. 10A is a part of a signal flow diagram illustrating a low latency link discovery method using location information of a terminal and base stations according to an exemplary embodiment of the present disclosure, and FIG. 10B is the remaining part of the signal flow diagram illustrating a low latency link discovery method using location information of a terminal and base stations according to an exemplary embodiment of the present disclosure.

FIGS. 10A and 10B constitute a continuous signal flow diagram. Therefore, the signal flows of FIG. 10B may be performed continuously after the signal flows of FIG. 10A. In addition, some operations in the signal flow diagram of FIGS. 10A and 10B may be omitted, and other operations may be additionally performed. Further, a sequence of some operations in the signal flow diagram of FIGS. 10A and 10B may be changed. These details will become clearer through the description below.

Components in FIGS. 10A and 10B are given reference numerals using the components illustrated in FIG. 8. In other words, the terminal 821, the first base station 831, the second base station 832, and the third base station 833 are illustrated, and each of the base stations 831 to 833 may be connected to the corresponding satellite (not shown in FIGS. 10A and 10B) through each feeder link. It should be noted that the satellites are omitted in FIGS. 10A and 10B due to complexity. In addition, each of the base stations 831 to 833 may be connected to the corresponding gateway. In describing FIGS. 10A and 10B, it should be noted that the base stations 831 to 833 may be base stations connected to the corresponding gateways.

In step S1000, the terminal 821 may be communicating with the first base station 831 over a first NTN link. Detailed links constituting the first NTN link through which the terminal 821 communicates with the first base station 831 will be described with reference to FIG. 8 described above. The terminal 821 may be connected to the first satellite 811 through a service link, and the first satellite 811 may be connected to the first base station 831 through a feeder link. Accordingly, the terminal 821 may communicate with the first base station 831 through the first satellite 811 using the first NTN link. In the following description, an entire link on which a terminal and a base station are connected through a satellite will be referred to as an NTN link. Accordingly, the entire link on which the terminal 821 is connected to the first base station 831 through the first satellite 811 will be referred to as the first NTN link.

Meanwhile, while the terminal 821 is communicating with the first base station 831 through the first NTN link, an NTN link may be additionally established with another base station through another satellite.

In step S1010, an operation in which the terminal 821 establishes a second NTN link with the second base station 832 through the second satellite 812 is illustrated. Describing this with reference to FIG. 8, the terminal 821 may establish the second NTN link with the second base station 832 through the second satellite 812. In this case, the second base station 832 may confirm that the terminal 821 has established the first NTN link, and based thereon, may inform the first base station 8310 that the second NTN link has been established.

Methods for the second base station 832 to confirm that a pre-established NTN link exists in the terminal 821 may be as follows.

First, the second base station 832 may receive information from a higher layer, for example, from the 5G core network, that the first NTN link has already been established in the terminal 821. Based thereon, the second base station 832 may confirm that another NTN link, for example, the first NTN link, has already been established in the terminal 821.

Second, the second base station 832 may confirm the state in which the first NTN link has been established based on information reported by the terminal 821. For example, when the terminal 821 performs an access procedure to the second base station 832, the terminal 821 may report information on the currently connected NTN link. In this case, the second base station 832 may confirm that another NTN link, for example, the first NTN link, has already been established in the terminal 821.

Through the two methods described above or other methods, the second base station 832 may confirm the existence of another NTN link during the operation of establishing the second NTN link. If another NTN link exists, the second base station 832 may inform the base station (e.g. the first base station 831) corresponding to the another link that the second NTN link has been established.

As another example in which the first base station 831 and the second base station 832 confirm establishment of another NTN link, the core network of the communication system (e.g. 5G communication system) may provide information on NTN link(s) currently connected with the terminal 821 to the first base station 831 and the second base station 832, respectively. In describing the present disclosure, the communication system will be described by taking the 5G communication system as an example. However, it should be noted that the present disclosure should not be understood as being limited to the 5G communication system, and may also be applied to all other communication systems to which the contents of the present disclosure are applicable.

Meanwhile, since the procedure of additionally establishing the NTN link in FIG. 10A is beyond the scope of the present disclosure, detailed descriptions of other operations related to the additional establishment of the NTN link will be omitted.

In step S1020, the terminal 821 may additionally establish a third NTN link with the third base station 833 through third satellite 813. Describing this with reference to FIG. 8, the terminal 821 may establish the third NTN link with the third base station 833 through the third satellite 813. When the NTN link is established, the third base station 833 may inform the base stations corresponding to other NTN links established in the terminal (e.g. the first and second base stations 831 and 832) that the third NTN link has been established. Alternatively, the core network of the 5G communication system may provide information on NTN link(s) currently connected with the terminal 821 to the first base station 831, the second base station 832, and the third base station 833, respectively.

In FIG. 10A, the description assumes that step S1020 (i.e. step in which the terminal 821 establishes the third NTN link with the third base station 833) is performed after step S1010 (i.e. step in which the terminal 821 establishes the second NTN link with the second base station 832). However, a sequence of the NTN link establishment procedures may change. In other words, the terminal 821 may first establish the third NTN link with the third base station 833, and then establish the second NTN link with the second base station 832.

In addition, FIG. 10A illustrates a case in which the third NTN link is additionally established after the terminal 821 establishes the second NTN link. However, the terminal 821 may establish only one additional NTN link after establishing the first NTN link. For example, the terminal 821 may additionally establish only the second NTN link with the second base station 832 through the second satellite 812 while communicating on the first NTN link, or the terminal 821 may additionally establish only the third NTN link with the third base station 833 through the third satellite 813 while communicating on the first link.

In step S1030, the first base station 831 may temporarily configure the first NTN link between the first base station 831 and the terminal 821 as a QuickLink. The present disclosure proposes a method for determining which NTN link among the first NTN link, second NTN link, and third NTN link is a QuickLink, and a method for operating the QuickLink.

Therefore, the first base station 831 may need to perform a procedure to determine which NTN link is a QuickLink.

In step S1040, the first base station 831 may perform a procedure for obtaining the location of the first NTN link. Here, the procedure for obtaining the location of the NTN link may include a procedure for obtaining the location of the base station, the location of the terminal, and the location of the satellite. In this case, since the location of the base station is already known, no additional procedure therefor is required. In addition, since the base station is connected to the gateway, it is assumed that the base station knows not only its own location but also the location of the gateway. Hereinafter, a procedure for obtaining the locations of the terminal and satellite in the procedure for obtaining the location of the NTN link will be described.

In step S1042, the first base station 831 may transmit a location information report request to the terminal 821 through the first satellite 811. In this case, when requesting a location information report, the first base station 831 may request only location information of the terminal 821, or may request location information of the terminal 821 and the first satellite 811 together. The first base station 831 may only request location information of the terminal 821 when the first base station 831 knows the location of the first satellite 811 or is capable of identifying the location of the first satellite 811 through calculation. On the other hand, if the location of the first satellite 811 is not known and cannot be identified through calculation, the first base station 831 may request the locations of the terminal 821 and the first satellite 811 together.

In general, the base station may know the location of the satellite or may be capable of identifying the location of the satellite through calculation. Therefore, in a general case, the first base station 831 may only request the location of the terminal 821 in step S1042. It should be noted that in FIG. 10A according to the present disclosure illustrates an example including a case where the first base station 831 does not know the location of the first satellite 811.

In addition, since the first base station 831 already knows its own location, it may not require a separate operation to acquire the location of itself with another node.

In step S1044, the terminal 821 may transmit its location information to the first satellite 811 through a location information report message. Then, the first satellite 811 may transmit a location information report message to the first base station 831 by including location information of the first satellite 811 in the location information report message received from the terminal. Through this procedure, the first base station 831 may confirm the location of the terminal 821 and the location of the first satellite 811.

In step S1050, the first base station 831 may perform a procedure for obtaining the location of the second NTN link. The procedure for obtaining the location of the second NTN link may include a procedure for obtaining the locations of the second base station 832, the second satellite 812, and the terminal 821 that constitute the second NTN link. As another example, the procedure for obtaining the location of the second NTN link may include a procedure for obtaining the locations of the second base station 832 and the second satellite 812. The case where the procedure for obtaining the location of the second NTN link obtains only the locations of the second base station 832 and the second satellite 812 may correspond to a case where the first base station 8131 has already obtained the location of the terminal 821 in the procedure for obtaining the location of the first NTN link. Therefore, since there is no need to repeatedly obtain the location of the terminal 821, the procedure for obtaining the location of the second NTN link may not require obtaining the location of the terminal.

Hereinafter, the procedure for obtaining the location of the second NTN link will be described in more detail.

In step S1052, the first base station 831 may transmit a location information request message. The location information request message may request at least one of the location of the second base station 832, the location of the second satellite 812, and the location of the terminal 821 which constitute the second NTN link. In this case, the location of the second satellite 812 may be an essential element. This is because the location of the second base station 832 may be obtained in advance when establishing the second NTN link described above. In addition, since the location of the terminal 821 has already been obtained in the procedure for obtaining the location of the first NTN link, redundant acquisition may not be necessary.

In step S1054, the second base station 832 may transmit a location information report request to the terminal 821 through the second satellite 812. As described above, step S1054 may not be performed if acquisition of the terminal's location is unnecessary. In addition, if the second base station 832 knows the location information of the second satellite 812 in advance or is capable of obtaining it through calculation, step S1054 may not be performed. If there is no need to identify the location of the terminal 821 and only the location of the second satellite 812 is needed, only the location information request may be transmitted to the second satellite 812.

In step S1056, the terminal 821 may transmit a location information report to the second base station 832. The location information report may include only the location of the terminal 821 or may include both the location of the terminal 821 and the location information of the second satellite 812.

In step S1058, the second base station 832 may report location information including information on the second satellite 812 to the first base station 831. At this time, the location information may additionally include at least one of the location of the terminal 821 and/or the location of the second base station 832.

In step S1050 described above, steps S1054 and S1056 may be unnecessary operations in a general satellite-based NTN environment. In general, each base station or gateway may know the location of a satellite connected to itself or is capable of identifying the location of the satellite through calculation. However, the NTN environment may be not limited to a case using satellites, and may also utilize aerial vehicles such as drones and/or balloons capable of staying in a specific orbit. Therefore, in order to enable the base station according to the present disclosure to be applied even when the exact locations of these aerial vehicles are not known at every moment, steps S1054 and S1056 are exemplified in the present disclosure.

In step S1060, the first base station 831 may perform a procedure for obtaining the location of the third NTN link. The procedure for obtaining the location of the third NTN link may be performed similarly to the procedure for obtaining the location of the second NTN link described above. Therefore, additional description on the procedure for obtaining the location of the third NTN link, which is redundant with that for the second NTN link, will be omitted.

Through the above-described operations, the first base station 831 may obtain the locations of the respective nodes corresponding to the first NTN link, the locations of the respective nodes corresponding to the second NTN link, and the locations of the respective nodes corresponding to the third NTN link. In addition, although NTN links using three different satellites are described in FIGS. 10A and 10B, the same may be applied to two NTN links as described in steps S1010 and S1020. In addition, even when four or more satellites are used, location information of each NTN link may be equally obtained based on the contents described in the present disclosure.

In step S1070, the first base station 831 may determine a QuickLink based on the location information obtained for the respective NTN links. The determination of the QuickLink may be performed based on the distances of the service links between the terminal and the satellites communicating with the terminal, the distances of the feeder links between the satellites and the corresponding base stations, and the distances between the gateways and the base stations. Each distance may be expressed as a time value, and may be calculated based on the TA value described in Equation 1 above, or a scheme other than the TA value may be used.

In step S1072a, the first base station 831 may transmit information on the determined QuickLink to the terminal 821 through the first satellite 811. That is, the first base station 831 may transmit information on the QuickLink to the terminal 821 through the first NTN link.

In step S1072b, the first base station 831 may transmit information on the determined QuickLink to the second base station 832. In addition, the first base station 831 may transmit information on the QuickLink to the third base station 833 in step S1072c.

FIG. 10B illustrates an example assuming that the third NTN link is determined the QuickLink. Accordingly, in step S1074, the third base station 833 may operate as the QuickLink.

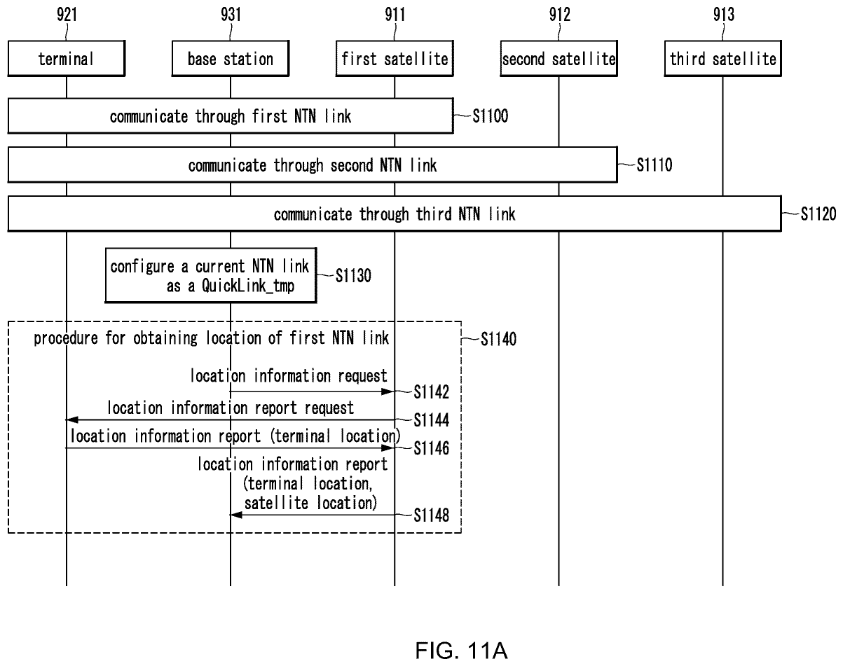

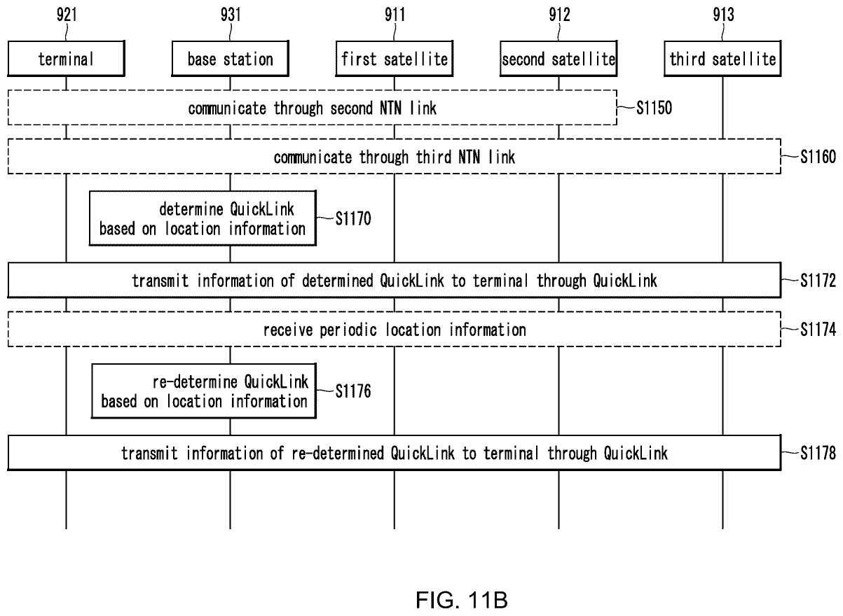

FIG. 11A is a part of a signal flow diagram illustrating a low latency link discovery method using location information of a terminal and base stations according to another exemplary embodiment of the present disclosure, and FIG. 11B is the remaining part of the signal flow diagram illustrating a low latency link discovery method using location information of a terminal and base stations according to another exemplary embodiment of the present disclosure.

FIGS. 11A and 11B constitute a continuous signal flow diagram. Therefore, the signal flows of FIG. 11B may be performed continuously after the signal flows of FIG. 11A. In addition, some operations in the signal flow diagram of FIGS. 11A and 11B may be omitted, and other operations may be additionally performed. Further, a sequence of some operations in the signal flow diagram of FIGS. 11A and 11B may be changed. These details will become clearer through the description below.

Components in FIGS. 11A and 11B are given reference numerals using the components illustrated in FIG. 9. In other words, the terminal 921, the base station 931, the first satellite 911, the second satellite 912, and the third satellite 913 are illustrated. Each of the satellites 911 to 913 may be connected with the terminal 921 through a service link. Each of the satellites 911 to 913 may be connected with the base station 931 through a feeder link. In addition, the base station 931 may be connected to a corresponding gateway. In describing FIGS. 11A and 11B, it should be noted that base station 931 may be a base station connected to the corresponding gateway.

In step S1100, the terminal 921 may be communicating with the base station 931 over a first NTN link. Detailed links constituting the first NTN link through which the terminal 921 communicates with the base station 931 will be described with reference to FIG. 9 described above. The terminal 921 may be connected to the first satellite 911 through a service link, and the first satellite 911 may be connected to the base station 931 through a feeder link. Accordingly, the terminal 921 may communicate with the base station 931 through the first satellite 911 using the first NTN link. In the following description, an entire link on which a terminal and a base station are connected through a satellite will be referred to as an NTN link. Accordingly, the entire link on which the terminal 921 is connected to the base station 931 through the first satellite 911 will be referred to as the first NTN link.

Meanwhile, while the terminal 921 is communicating with the base station 931 through the first NTN link, an NTN link may be additionally established with another base station through another satellite.

In step S1110, an operation in which the terminal 921 establishes a second NTN link with the base station 931 through the second satellite 912 is illustrated. Describing this with reference to FIG. 9, the terminal 921 may establish the second NTN link with the base station 931 through the second satellite 912. In this case, the base station 931 may confirm that the terminal 921 has established the first NTN link.

Meanwhile, since the procedure of additionally establishing the NTN link in FIG. 11A is beyond the scope of the present disclosure, detailed descriptions of other operations related to the additional establishment of the NTN link will be omitted.

In step S1120, the terminal 921 may additionally establish a third NTN link with the base station 931 through the third satellite 913. Describing this with reference to FIG. 9, the terminal 921 may establish the third NTN link with the base station 931 through the third satellite 913. When the NTN link is established, the base station 931 may identify other NTN links established in the terminal 921.

In FIG. 11A, the description assumes that step S1120 (i.e. step in which the terminal 921 establishes the third NTN link with the third satellite 913) is performed after step S1110 (i.e. step in which the terminal 921 establishes the second NTN link with the second satellite 912). However, a sequence of the NTN link establishment procedures may change. In other words, the terminal 921 may first establish the third NTN link with the third satellite 913, and then establish the second NTN link with the second satellite 912.

In addition, FIG. 11A illustrates a case in which the third NTN link is additionally established after the terminal 921 establishes the second NTN link. However, the terminal 921 may establish only one additional NTN link after establishing the first NTN link. For example, the terminal 921 may additionally establish only the second NTN link with the base station 931 through the second satellite 812 while communicating on the first NTN link, or the terminal 921 may additionally establish only the third NTN link with the base station 931 through the third satellite 913 while communicating on the first link.

In step S1130, the first base station 931 may temporarily configure the first NTN link between the first satellite 911 and the terminal 921 as a QuickLink. The present disclosure proposes a method for determining which NTN link among the first NTN link, second NTN link, and third NTN link is a QuickLink, and a method for operating the QuickLink.

Therefore, the base station 931 may need to perform a procedure to determine which NTN link is a QuickLink.

In step S1140, the base station 931 may perform a procedure for obtaining the location of the first NTN link. Here, the procedure for obtaining the location of the NTN link may include a procedure for obtaining the location of the base station, the location of the terminal, and the location of the satellite. In this case, since the location of the base station is already known, no additional acquisition procedure is required. In addition, since the base station is connected to the gateway, it is assumed that the base station knows not only its own location but also the location of the gateway. Hereinafter, the procedure for obtaining the locations of the terminal and satellite in the procedure for obtaining the location of the NTN link will be described.

In step S1142, the base station 931 may transmit a location information report request to the terminal 921 through the first satellite 911. In this case, when requesting a location information report, the base station 931 may request only location information of the terminal 921, or may request location information of the terminal 921 and the first satellite 911 together. The base station 931 may only request location information of the terminal 921 when the base station 931 knows the location of the first satellite 911 or is capable of identifying the location of the first satellite 811 through calculation. On the other hand, if the location of the first satellite 911 is not known and cannot be identified through calculation, the base station 931 may request the locations of the terminal 921 and the first satellite 911 together.

In general, the base station may know the location of the satellite or may be capable of identifying the location of the satellite through calculation. Therefore, in a general case, the base station 931 may only request the location of the terminal 921 in step S1142. It should be noted that in FIG. 11A according to the present disclosure illustrates an example including a case where the base station 931 does not know the location of the first satellite 911.

In addition, since the base station 931 already knows its own location, it may not require a separate operation to acquire the location of itself with another node.

In step S1144, the first satellite 911 may transmit a location report request message to the terminal 921. In step S1146, the terminal 921 may transmit its location information to the first satellite 911 through a location information report message. Based on the location information report message transmitted by the terminal 921, the first satellite 811 may transmit the location information report message as is to the base station 931 in step S1148 or transmit the location information report message to the base station 931 by including its own location information therein. Through this procedure, the base station 931 may confirm the location of the terminal 921, or both the location of the terminal 921 and the location of the first satellite 911.

In step S1150, the base station 931 may perform a procedure for obtaining the location of the second NTN link. In general, the base station 931 may know the location of the second satellite 912 or is capable of identifying the location of the second satellite 912 through calculation. Therefore, the procedure for obtaining the location of the second NTN link may be performed based on the location information already known by the second satellite 912.

In step S1160, the base station 931 may perform a procedure for obtaining the location of the third NTN link. As previously described in step S1150, the base station 931 may know the location of the third satellite 913 or is capable of identifying the location of the third satellite 913 through calculation. Therefore, the procedure for obtaining the location of the third NTN link may be performed based on the location information already known by the second satellite 912.

Therefore, the case where the base station 931 performs steps S1150 and S1160 may be an unusual case. For example, the NTN environment is not limited to satellites, and may also utilize aerial vehicles such as drones and/or balloons capable of staying in a specific orbit. In this case, the base station may not be able to know the exact locations of these aerial vehicles at every moment. The present disclosure exemplifies steps S1150 and S1160 to apply even when the exact locations of the aerial vehicles are unknown. In addition, it should be noted that steps S1150 and S1160 may be performed only when necessary, so they are indicated with dotted lines.

In step S1170, the base station 931 may determine a QuickLink based on the location information obtained for the respective NTN links. The QuickLink may be determined based on the distances of the service links between the terminal and the satellites communicating with the terminal, the distances of the feeder links between the satellites and the corresponding base station, and the distances between the gateway and the base station. Each of these distances may be expressed as a time value, and may be calculated based on the TA value described in Equation 1 above, or a method other than the TA value may be used.

In step S1172, the base station 931 may transmit information on the determined QuickLink through the determined QuickLink. For example, if the first NTN link is determined to be the QuickLink, the base station 931 may inform the terminal 921 through the first satellite 911 that the determined QuickLink is the link of the first satellite 911. As another example, if the second NTN link is determined to be the QuickLink, the base station 931 may inform the terminal 921 through the second satellite 912 that the determined QuickLink is the link of the second satellite 912. As another example, if the third NTN link is determined to be the QuickLink, the base station 931 may inform the terminal 921 through the third satellite 913 that the determined QuickLink is the link of the third satellite 913.

As another example, the base station 931 may transmit information on the determined QuickLink to the terminal 921 through the first satellite 911, which is the initially established NTN link.

As another example, the base station 931 may transmit information on the determined QuickLink through a link with the highest signal strength based on link signal strength information reported by the terminal 921.

In step S1174, the base station 931 may receive periodic location information from the terminal 921. The periodic transmission of location information of the terminal 921 may be configured by the base station 931 through a specific control message (e.g. RRC message) which establishing the NTN link. Accordingly, the terminal 921 may report location information of the terminal 921 to the base station 931 through the QuickLink informed in step S1172.

In step S1176, the base station 931 may reconfigure the QuickLink based on the location information reported by the terminal 921. If the terminal 921 moves at high speed or elevation angles between the terminal 921 and the satellites change based on the movement of the terminal 921 even if the terminal 921 does not move at high speed, the distances between the satellites and the terminal 921 may vary. In particular, if the NTN does not use satellites but uses aerial vehicles such as drones or balloons, they may have lower altitudes than the satellites. Therefore, as the terminal 921 moves, the elevation angles between the terminal 921 and the aerial vehicles may change significantly. The change in elevation angles may ultimately mean that the distances between the terminal and the aerial vehicles change.

Further, the satellites may move at very high speeds. Therefore, as the satellites move at high speed, the elevation angles between the satellites and the terminal may vary. Based on these changes, the distances between the terminal and the satellites may change. Therefore, the base station 931 may need to periodically re-determine the QuickLink. For the periodic re-determination, the location information of the terminal 921 reported from the terminal 921 may be used.

In step S1178, the base station 931 may transmit information on the re-determined QuickLink to the terminal 921 through the re-determined QuickLink or a preconfigured specific link.

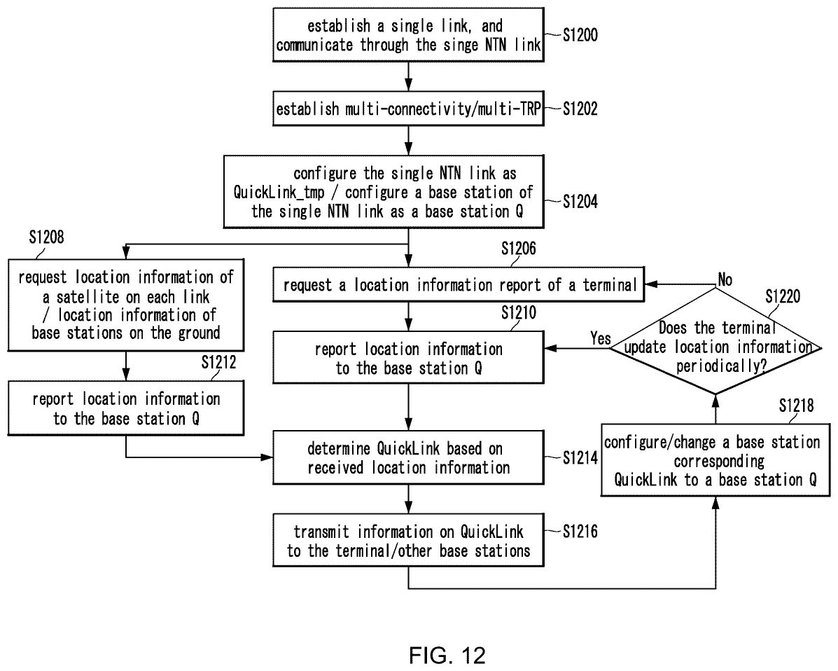

FIG. 12 is a flowchart of an operation of an NTN according to a first exemplary embodiment of the present disclosure.

Hereinafter, overall operations of the exemplary embodiment previously described in FIGS. 10A and 10B and the exemplary embodiment described in FIGS. 11A and 11B will be described with reference to FIG. 12.

In step S1200, the terminal and the base station may establish a single NTN link and communicate over the single NTN link.

Describing step S1200 with reference to FIG. 8, the first base station 831 may establish the first NTN link with the terminal 821 through the first satellite 811, and communicate with the terminal 821 through the established first NTN link.

Describing step S1200 with reference to FIG. 9, the base station 931 may establish the first NTN link with the terminal 921 through the first satellite 911, and communicate with the terminal 921 through the established first NTN link. Therefore, the terminal may communicate with the base station through the single NTN link connected to one satellite.

In step S1202, the terminal may establish multi-connectivity or multi-TRP environment by connecting to at least one other satellite in addition to the single connected satellite.

Describing step S1202 with reference to FIG. 8, a case may occur in which the terminal 821 is able to also receive signals from the second satellite 812 while communicating with the first base station 831 through the first NTN link. If the terminal 821 is able to receive signals from both the first satellite 811 and the second satellite 812, multi-connectivity through multiple satellites may be established for the terminal 821. Each of the base stations 831 to 833 may configure its own communication coverage based on beams transmitted by the corresponding satellite 811, 812, or 813. In addition, each of the base stations 831 to 833 may attempt multi-connectivity for the terminal located within its communication coverage. Since a manner in which multi-connectivity is established is beyond the scope of the present disclosure, it will not be described in detail.

When multi-connectivity is required, the second base station 832 may establish the second NTN link with the terminal 821 through the second satellite 812 and communicate with the terminal 821 through the established second NTN link. In addition, the third base station 833 may establish the third NTN link with the terminal 821 through the third satellite 813 and communicate with the terminal 821 through the established third NTN link. When at least one NTN link of the second NTN link or the third NTN link is additionally established while the first NTN link is established in the terminal 821, the terminal 821 may establish multi-connectivity through the plurality of satellites.

Describing step S1202 with reference to FIG. 9, the base station 931 may determine whether the terminal 921 is within the communication coverage of the first satellite 911, and simultaneously within the communication coverage of the second satellite 912 and/or the third satellite 913. In addition, when transmitting data to the terminal 921, the base station 931 may need to transmit data using two or more satellites, such as when the amount of data to be transmitted to the terminal 921 increases rapidly. In this case, the base station 931 may additionally establish link(s) other than the currently established NTN link with the plurality of satellites.

When data needs to be transmitted to the terminal 921 through multiple NTN links, the base station 931 may establish the second NTN link with the terminal 921 through the second satellite 912, and communicate with the terminal 921 through the established second NTN link. Here, the case of being connected to the terminal through the second NTN link, specifically the second satellite 912, has been mentioned, but the third NTN link may be used instead of the second NTN link. In other words, the base station 931 may establish the third NTN link with the terminal 921 through the third satellite 913 and communicate with the terminal 921 through the established third NTN link. The case where at least one of the second NTN link or the third NTN link is additionally established while the first NTN link is established in the terminal 921 may correspond to a case where the respective satellites are configured as multiple TRPs.

In step S1204, the base station may configure a single NTN link as a temporary QuickLink (i.e. QuickLink_tmp) and configure the base station as a base station Q. In the present disclosure, the base station Q may be a base station with a QuickLink. The base station Q may announce QuickLink_tmp to other nodes, for example, terminals and base stations, or terminals and satellites. If a QuickLink can be determined quickly, the base station Q may be configured not to announce QuickLink_tmp to other nodes.

Describing step S1204 with reference to FIG. 8, the first base station 831 may configure the first NTN link connected to the terminal 821 through the first satellite 811 as QuickLink_tmp. Since the first base station 831 is a base station that only has a single NTN link, the first base station 831 may configure itself as the base station Q. Here, the first base station 831 may be understood as including a gateway connected to the first base station 831. In addition, the first base station 831 may inform other base stations, such as the second base station 832 and/or the third base station 833, of information that the first base station 831 is the base station Q. In addition, the first base station 831 may inform the terminal 821 of information that itself is the base station Q.

Describing step S1204 with reference to FIG. 9, the base station 931 may configure the first NTN link connected to the terminal 921 through the first satellite 911 as QuickLink_tmp. The base station 931 may inform the terminal 921 that the first NTN link is selected as QuickLink_tmp. Since the case of FIG. 9 is a case where a plurality of satellites are connected to the base station 931, the operation of configuring the base station Q is not necessary. Therefore, the first base station 931 may only inform the terminal 921 of information on QuickLink_tmp.

In step S1206, the base station may request location information of the terminal through the configured QuickLink_tmp. The first exemplary embodiment of the present disclosure has described methods for discovering a low latency link using location information. Therefore, the operation of step S1206 may correspond to a method of using location information as low latency link-related information. The location information mentioned in the present disclosure may include the following information. First, the location information may simply be information on a current location. Second, the location information may include additional location information in addition to the current location. The additional location information may be information for predicting a location at a specific time. For example, the additional location information may include information used for calculating (or predicting) a near future location, such as a first derivative (i.e. velocity) and/or a second derivative (i.e. acceleration) of movement of a specific node over a predetermined period of time. In the following description, the location information may include the additional location information if the target node is not a fixed node.

In addition, the request for location information of the terminal may be notified to the terminal by transmitting a specific indicator or a specific message to indicate the terminal to report the current location information. The reason the base station needs the location information of the terminal is to identify the length of the service link. Therefore, the base station may transmit an indicator or message to the terminal to indicate the terminal to report the terminal's current location information to the base station. The message or indicator may be implemented differently depending on each communication system. For example, the base station may use an RRC message to configure a location report and location reporting periodicity to the terminal. As another example, if the specifications allow adding a location report indicator to downlink control information (DCI), the base station may indicate the terminal to perform location reporting through DCI.

Describing step S1206 with reference to FIG. 8, the first base station 831 configured as the base station Q may transmit a terminal location information report request message or location report indicator to the terminal 821 through the first satellite 811 of the first NTN link configured as QuickLink_tmp.

Describing step S1206 with reference to FIG. 9, the base station 831 may transmit a terminal location information report request message or a location report indicator to the terminal 921 through the first satellite 911 of the first NTN link configured as QuickLink_tmp.

In step S1208, base station Q may request the location information of the satellite on each link, as well as the location information of other base stations on the ground and/or gateways connected to other base stations. The locations of other base stations on the ground and satellites, or the locations of the gateways and satellites connected to the other base stations, may be necessary to determine the lengths or delays of the service links and feeder links.

Describing step S1208 with reference to FIG. 8, the first base station 831, configured as base station Q, may request the location information of the satellite connected to each base station, the location information of the gateway, and/or the location information of each base station from the second base station 832 and/or the third base station 833. The first base station 831 may request the location information of the satellite connected to each base station, the location information of the gateway, and/or the location information of each base station from the second base station 832 and/or the third base station 833 by using a backhaul or Xn interfaces between the base stations.

Describing step S1208 with reference to FIG. 9, the base station 931 may request location information from each of the satellites 911 to 913. If the base station 931 knows the locations of the respective satellites 911 to 913 in advance or is capable of identifying them through calculation, step S1208 may not be performed.

According to the order of descriptions and the order of reference numerals, step S1208 has been described as being performed after performing step S1206. However, steps S1206 and S1208 may be performed simultaneously, or step S1208 may be performed first and step S1206 may be performed later.

In step S1210, the terminal may generate location information based on the location information report request of step S1206, and report the location information to the base station Q through the satellite of the NTN link from which the location information report request is received.

Describing step S1210 with reference to FIG. 8, the terminal 821 may generate location information of the terminal based on the location information report request received in step S1206, and report a location information report message of the terminal to the first base station 831 through the first satellite (i.e. first NTN link). This operation may correspond to step S1044 previously described in FIG. 10A.

Describing step S1210 with reference to FIG. 9, the terminal 921 may generate location information of the terminal based on the location information report request received in step S1206, and report a location information report message of the terminal to the base station 931 through the first satellite (i.e. first NTN link). This operation may correspond to steps S1146 to S1148 previously described in FIG. 11A.

In step S1212, other base station(s) and/or other satellite(s) may generate their own location information based on the location information request in step S1208, and report the generated location information to the base station Q.

Meanwhile, steps S1208 and S1212 may correspond to a procedure for the base station Q to obtain location information of other base station(s) (or base station(s) and gateway(s)) and location information of the satellites. Therefore, when a new QuickLink is configured, a new base station Q may perform steps S1208 and S1212. In addition, the base station and/or gateway generally has a fixed location. Therefore, when a new QuickLink is configured, the previous base station Q may provide the location information of the base stations and/or gateways to a new base station Q of the new QuickLink. If the previous base station Q provides the location information of the base stations and/or gateways to the new base station Q of the new QuickLink, the new base station Q of the new QuickLink may not request the location information of the base stations and/or gateways having different NTN links.

In addition, the previous base station Q may provide the new base station Q of the new QuickLink with the locations of the satellites having feeder links corresponding to the respective base stations and additional information of the satellites (e.g. altitudes, movement speeds, and movement paths of the satellites). If the previous base station Q provides the additional information of the respective satellites to the new base station Q of the new QuickLink, and the locations of the satellites can be predicted based thereon, the new base station Q of the new QuickLink may not even request location information of the satellites.

On the other hand, if the previous base station Q does not provide the information described above to the new base station Q of the new QuickLink, the new base station Q of the new QuickLink may perform steps S1208 and S1212 at least once. In order to obtain information of the satellites, the new base station Q of the new QuickLink may perform steps S1208 and S1212 at a predetermined time interval.

Describing step S1212 with reference to FIG. 8, the second base station 832 may generate a location information report message to report its own location information and/or location information of the gateway connected to the second base station 832 based on the location information request of step S1208, and transmit the generated location information report message to the first base station 831. In this case, the location information report message transmitted from the second base station 832 to the first base station 831 may be transmitted through a backhaul or Xn interface connected between the base stations. In addition, the third base station 833 may transmit a location information report message to the first base station 831 using the same method as the second base station 832.

Describing step S1212 with reference to FIG. 9, the second satellite 912 may generate its own location information as a location information report message based on the location information request of step S1208, and transmit the generated location information report message to the base station 931. In this case, the location information report message transmitted from the second satellite 912 to the base station 931 may be transmitted through the feeder link. In addition, as described above, if the base station 931 knows the locations, movement paths, and speeds of all satellites, the operation of step S1212 may be omitted in the multi-TRP environment as shown in FIG. 9.

The situation where the base station cannot obtain the location information of the satellites in steps S1208 and S1212 described above may include cases where aerial vehicles, rather than satellites, are used, as previously described in FIGS. 10A and 10B or 11A and 11B.

In step S1214, the base station Q may receive location information of the terminal, location information of the respective satellites, and location information of the gateways and base stations communicating with the satellites. Therefore, the base station Q may determine a QuickLink based on the received location information. The QuickLink may be determined based on the lengths of the service links (distance between nodes on each service link) and the lengths of the feeder links (distance between nodes on each feeder link). The length of the service link may be obtained based on the location of the terminal and the location of the satellite. In addition, the length of the feeder link may be obtained based on the distance between the satellite and the gateway or the distance between the satellite and the base station (e.g. when the base station is located in the same place as the gateway or the base station and gateway are configured as one entity).

In the multi-connectivity environment described in FIG. 8 or the multi-TRP environment described in FIG. 9, one satellite corresponds to one NTN link. Therefore, there may be several methods to identify which satellite link has a low latency. In the present disclosure, one of these methods will be described as an example.

A low latency link according to the present disclosure, that is, Quick Link, may be calculated as shown in Equation 2 below.

$${T}_{QL} - {T}_{min} > γ \qquad [ Equation 2 ]$$

In Equation 2, T_{QL} represents a propagation delay in a radio channel of the current QuickLink (i.e. service link+feeder link). If a QuickLink is not configured, T_{QL} represents a propagation delay of QuickLink_tmp. When a sum of propagation delays of the service link and the feeder link for each NTN link i among multiple NTN links is Tᵢ, Tₘᵢₙ may be defined as the minimum value of Tᵢ for the respective NTN links. γ is a threshold.

In the above-described scheme, a change sensitivity of QuickLink may be adjusted using the threshold. For example, if the threshold is set to a large value, change of the QuickLink may not occur quickly, and if the threshold is set to a small value, change of the QuickLink may occur quickly. Therefore, based on a result of Equation 2, it may be decided whether to update or maintain the current QuickLink. If the QuickLink is determined to be updated to a new QuickLink, a link corresponding to Tₘᵢₙ may be selected as the new QuickLink.

In step S1216, the base station operating as Q_tmp may transmit information on the determined QuickLink to the terminal and other base stations.

Describing step S1216 with reference to FIG. 8, the first base station 831 operating as the base station Q may transmit information on the determined QuickLink to the terminal 821 through the first NTN link, which is QuickLink_tmp. In addition, the first base station 831 operating as the base station Q may transmit information on the determined QuickLink to the second base station 832 and/or the third base station 833 using a backhaul or Xn interface connected between the base stations.

Describing step S1216 with reference to FIG. 9, the base station 931 may transmit information on the determined QuickLink to the terminal 921 through the first satellite 911 of the first NTN link, which is QuickLink_tmp. In the case of FIG. 9, since there are no other base stations, there is no need to transmit information on the determined QuickLink to other base stations.

QuickLink information transmitted in step S1216 may include the following two types of information.
(1) Information identifying a satellite for the newly designated QuickLink and/or a base station connected to the satellite: Through this information, terminals and base stations may identify which link is a QuickLink. In case of multi-TRP environment, since all links are connected to one base station, the terminal needs to be informed which link/satellite is the QuickLink.
(2) Application time for the newly designated QuickLink: In order to synchronize times when all base stations participating in the multiple links with the terminal apply the newly designated QuickLink, time information such as a frame number or sub-frame number, may be informed to synchronize application times of the QuickLink.

In step S1218, the terminal and base stations may configure the corresponding base station as the base station Q based on the QuickLink information.

Describing step S1218 with reference to FIG. 8, the first base station 831 may configure the base station Q based on the QuickLink determined in step S1214. In addition, the second base station 832 and the third base station 833 may also configure the base station Q based on the QuickLink determined in step S1214. Then, the terminal 821 may delete QuickLink_tmp, and configure the QuickLink based on the information received in step S1214. In other words, all base stations may identify the QuickLink and which base station is the base station Q.

For example, if the first base station 831 is configured as the base station Q and the first NTN link is determined to be the QuickLink, the first base station 831 may configure the first NTN link through itself as the QuickLink, and configure itself as the base station Q. Accordingly, the first base station 831 may subsequently perform the operations corresponding to the base station Q described in FIG. 12. As another example, if the second base station 832 is configured as the base station Q and the second NTN link is determined to be the QuickLink, the second base station 832 may configure the second NTN link through itself as the QuickLink, and configure itself as the base station Q. Accordingly, the second base station 832 may subsequently perform the operations corresponding to the base station Q described in FIG. 12. In this case, if a base station corresponding to the previous QuickLink is the first base station 831, the first base station 831 may become a base station other than the base station Q.

Describing step S1218 with reference to FIG. 9, the base station 931 may configure the QuickLink based on the QuickLink determined in step S1214. In the case of FIG. 9, each of the satellites 911 to 913 operates as a TRP, so the base station Q may not be changed or the base station Q may not be defined. However, the base station may determine whether the QuickLink is the first NTN link, the second NTN link, or the third NTN link.

Meanwhile, the operations described above, specifically steps S1216 and S1218, may be operations for transmitting information and configuring the base station Q when a new QuickLink is determined. Therefore, if there is no change in QuickLink based on the determination in step S1214, steps S1216 and S1218 may be omitted.

Step S1220 may be an operation performed when the base station Q configures the terminal to report location information periodically. Therefore, the base station Q may proceed to step S1210 when periodic location information is updated from the terminal.

If the terminal is not configured to report location information periodically, the base station Q may proceed to step S1206. In addition, the case of proceeding to step S1206 may occur at a predetermined time interval, and when performing step S1206, step S1208 may also be performed. For example, as described above, if the NTN includes satellite(s) and/or aerial vehicle(s), step S1208 may need to be additionally performed. Therefore, when receiving location information from the terminal, step S1210 may be performed alone, or steps S1208 and S1210 may be performed together.

### Second Exemplary Embodiment: Low Latency Link Discovery Using Latency Information for Respective Links

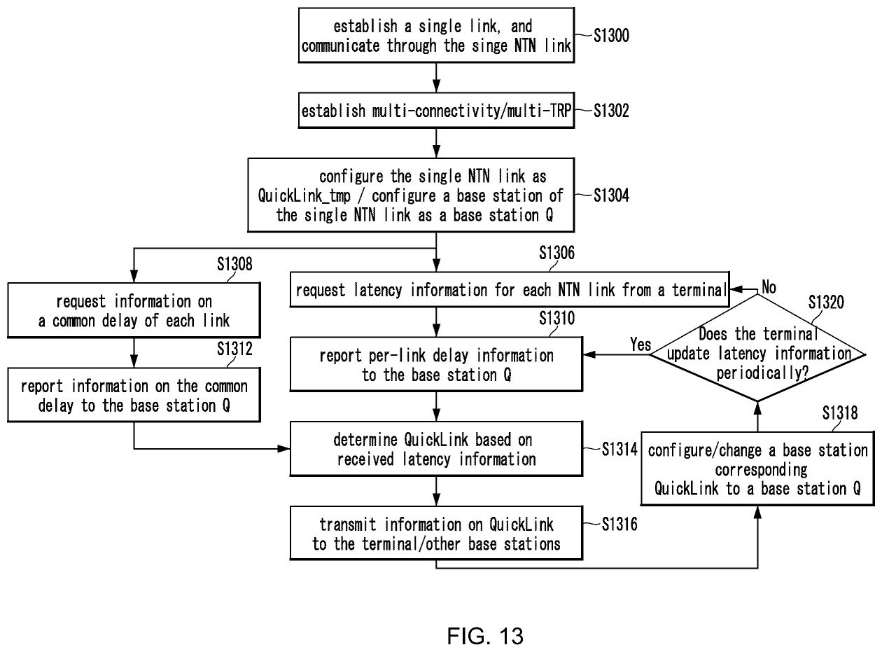

FIG. 13 is a flowchart of operations of an NTN according to a second exemplary embodiment of the present disclosure.

Hereinafter, the overall operations of the second exemplary embodiment of the present disclosure will be described with reference to FIG. 13.

In step S1300, the terminal and the base station may establish a single NTN link and communicate over the single NTN link.

Describing step S1300 with reference to FIG. 8, the first base station 831 may establish the first NTN link with the terminal 821 through the first satellite 811, and communicate with the terminal 821 through the established first NTN link.

Describing step S1300 with reference to FIG. 9, the base station 931 may establish the first NTN link with the terminal 921 through the first satellite 911 and communicates with the terminal 921 through the established first NTN link. Therefore, the terminal may communicate with the base station through the single NTN link connected to one satellite.

In step S1302, the terminal may establish multi-connectivity or multi-TRP environment by connecting to at least one other satellite in addition to the single connected satellite.

Describing step S1302 with reference to FIG. 8, a case may occur in which the terminal 821 is able to also receive signals from the second satellite 812 while communicating with the first base station 831 through the first NTN link. If the terminal 821 is able to receive signals from both the first satellite 811 and the second satellite 812, multi-connectivity through multiple satellites may be established for the terminal 821. Each of the base stations 831 to 833 may configure its own communication coverage based on beams transmitted by the corresponding satellite 811, 812, or 813. In addition, each of the base stations 831 to 833 may attempt multi-connectivity for the terminal located within its communication coverage. Since a manner in which multi-connectivity is established is beyond the scope of the present disclosure, it will not be described in detail.

When multi-connectivity is required, the second base station 832 may establish the second NTN link with the terminal 821 through the second satellite 812 and communicate with the terminal 821 through the established second NTN link. In addition, the third base station 833 may establish the third NTN link with the terminal 821 through the third satellite 813 and communicate with the terminal 821 through the established third NTN link. When at least one NTN link of the second NTN link or the third NTN link is additionally established while the first NTN link is established in the terminal 821, the terminal 821 may establish multi-connectivity through the plurality of satellites.

Describing step S1302 with reference to FIG. 9, the base station 931 may determine whether the terminal 921 is within the communication coverage of the first satellite 911, and simultaneously within the communication coverage of the second satellite 912 and/or the third satellite 913. In addition, when transmitting data to the terminal 921, the base station 931 may need to transmit data using two or more satellites, such as when the amount of data to be transmitted to the terminal 921 increases rapidly. In this case, the base station 931 may additionally establish link(s) other than the currently established NTN link with the plurality of satellites.

When data needs to be transmitted to the terminal 921 through multiple NTN links, the base station 931 may establish the second NTN link with the terminal 921 through the second satellite 912, and communicate with the terminal 921 through the established second NTN link. Here, the case of being connected to the terminal through the second NTN link, specifically the second satellite 912, has been mentioned, but the third NTN link may be used instead of the second NTN link. In other words, the base station 931 may establish the third NTN link with the terminal 921 through the third satellite 913 and communicate with the terminal 921 through the established third NTN link. The case where at least one of the second NTN link or the third NTN link is additionally established while the first NTN link is established in the terminal 921 may correspond to a case where the respective satellites are configured as multiple TRPs.

In step S1304, the base station may configure a single NTN link as a temporary QuickLink (i.e. QuickLink_tmp) and configure the base station as a base station Q. In the present disclosure, the base station Q may be a base station with a QuickLink. The base station Q may announce QuickLink_tmp to other nodes, for example, terminals and base stations, or terminals and satellites. If a QuickLink can be determined quickly, the base station Q may be configured not to announce QuickLink_tmp to other nodes.

Describing step S1304 with reference to FIG. 8, the first base station 831 may configure the first NTN link connected to the terminal 821 through the first satellite 811 as QuickLink_tmp. Since the first base station 831 is a base station that only has a single NTN link, the first base station 831 may configure itself as the base station Q. Here, the first base station 831 may be understood as including a gateway connected to the first base station 831. In addition, the first base station 831 may inform other base stations, such as the second base station 832 and/or the third base station 833, of information that the first base station 831 is the base station Q. In addition, the first base station 831 may inform the terminal 821 of information that itself is the base station Q.

Describing step S1304 with reference to FIG. 9, the base station 931 may configure the first NTN link connected to the terminal 921 through the first satellite 911 as QuickLink_tmp. The base station 931 may inform the terminal 921 that the first NTN link is selected as QuickLink_tmp. Since the case of FIG. 9 is a case where a plurality of satellites are connected to the base station 931, the operation of configuring the base station Q is not necessary. Therefore, the first base station 931 may only inform the terminal 921 of information on QuickLink_tmp.

In step S1306, the base station may transmit an indicator to the terminal to indicate to report latency information of all communicating NTN links through the configured QuickLink_tmp. The second exemplary embodiment of the present disclosure describes methods for discovering a low latency link using latency information. Therefore, the operation of step S1306 may correspond to a method of using latency information as low latency link-related information. In this case, the base station may indicate the terminal to report the latency information at a predetermined periodic interval.

Since there is no particular difference in the operation of step S1306 between the case of FIG. 8 and the case of FIG. 9, separate description will be omitted. However, if satellites operate as multiple TRPs as shown in FIG. 9, all the satellites may be connected to one base station. Therefore, if the satellites operate as multiple TRPs, step S1310 may be omitted.

In step S1308, the base station Q may request information on a common delay for each NTN link from each base station.

Describing step S1308 with reference to FIG. 8, the first base station 831 operating as the base station Q may request information on a common delay for each NTN link through each satellite connected to each base station from the second base station 832 and/or the third base station 833. A common delay for each of the NTN links may be a delay of the corresponding feeder link. Since a base station and a gateway are always located in specific locations on the ground, and they do not move, only satellite(s) connected to each base station may move. Therefore, the delay of the feeder link may be a common delay for all terminals connected to the satellite. Therefore, the information on the common delay may be information on the delay of the feeder link for each of the NTN links. The request for the feeder link delay or common delay for each of the NTN links connected to each base station, which is transmitted from the first base station 831 to the second base station 832 and/or the third base station 833, may use a backhaul or Xn interfaces between base stations.

In the case of FIG. 9 in which a plurality of satellites operate as multiple TRPs, the operation of step S1308 may not be performed because there is only one base station. That is, since the base station 931 knows the delays of feeder links for the respective satellites 911 to 913, there is no need to perform step S1308. Therefore, in the case of FIG. 9 in which a plurality of satellites operate as multiple TRPs, the base station may not perform step S1312, which will be described below.

According to the order of descriptions and the order of reference numerals, step S1308 has been described as being performed after step S1306. However, steps S1306 and S1308 may be performed simultaneously, or step S1308 may be performed first, and then step S1306 may be performed.

In step S1310, the terminal may generate per-link delay information for each of all NTN links based on the request to report latency information for all NTN links in step S1306. In addition, the terminal may configure the per-link delay information into each message or generate one message including the per-link delay information for all NTN links, and report the delay information to the base station Q through the satellite of the NTN link through which the request for the delay information is received. In this case, if the terminal does not know the feeder link delay for one of the NTN links, the terminal may report delay information excluding the feeder link delay of the corresponding NTN link to the base station. If information on a feeder link delay of a specific NTN link is excluded, the terminal may include information indicating that there is no feeder link delay information for the corresponding NTN link in the report message.

Since the operation of step S1310 does not differ between multi-connectivity and multiple TRP environments, descriptions referring to FIGS. 8 and 9 will be omitted. However, if satellites operate as multiple TRPs as shown in FIG. 9, all satellites may be connected to one base station. Therefore, if satellites operate as multiple TRPs, step S1310 may be omitted.

In step S1312, each of other base stations may report information on the delay of the feeder link between itself and the corresponding satellite to the base station Q based on the common delay information report request of step S1308.

Meanwhile, steps S1308 and S1312 may be a procedure for the base station Q to obtain information on common delays of other base stations (or base stations and gateways). Therefore, when a new QuickLink is configured, a new base station Q may perform steps S1308 and S1312.

In step S1314, since the base station Q receives latency information for each NTN link and information on a common delay for each base station from the terminal, the base station Q may determine a QuickLink based thereon. Given the latency information for each NTN link, the base station Q may identify which satellite link has low latency in several schemes. One of these schemes may use Equation 2 described above. Since Equation 2 has been described in the first exemplary embodiment, redundant description will be omitted.

In step S1316, the base station Q may transmit information on the determined QuickLink to the terminal and other base stations.

Describing step S1316 with reference to FIG. 8, the first base station 831 operating as the base station Q may transmit information on the determined QuickLink to the terminal 821 through the first NTN link, which is QuickLink_tmp. In addition, the first base station 831 operating as the base station Q may transmit information on the determined QuickLink to the second base station 832 and/or the third base station 833 using a backhaul or Xn interface connected between the base stations.

Describing step S1316 with reference to FIG. 9, the base station 931 may transmit information on the determined QuickLink to the terminal 921 through the first satellite 911 of the first NTN link, which is QuickLink_tmp. In the case of FIG. 9, since there are no other base stations, there is no need to transmit information on the determined QuickLink to other base stations.

QuickLink information transmitted in step S1316 may include the following two types of information.
(1) Information identifying a satellite for the newly designated QuickLink and/or a base station connected to the satellite: Through this information, terminals and base stations may identify which link is a QuickLink. In case of multi-TRP environment, since all links are connected to one base station, the terminal needs to be informed which link/satellite is the QuickLink.
(2) Application time for the newly designated QuickLink: In order to synchronize times when all base stations participating in the multiple links with the terminal apply the newly designated QuickLink, time information such as a frame number or sub-frame number, may be informed to synchronize application times of the QuickLink.

In step S1318, the terminal and base stations may configure the corresponding base station as the base station Q based on the QuickLink information.

Describing step S1318 with reference to FIG. 8, the first base station 831 may configure the base station Q based on the QuickLink determined in step S1314. In addition, the second base station 832 and the third base station 833 may also configure the base station Q based on the QuickLink determined in step S1314. Then, the terminal 821 may delete QuickLink_tmp, and configure the QuickLink based on the information received in step S1314. In other words, all base stations may identify the QuickLink and which base station is the base station Q.

For example, if the first base station 831 is configured as the base station Q and the first NTN link is determined to be the QuickLink, the first base station 831 may configure the first NTN link through itself as the QuickLink, and configure itself as the base station Q. Accordingly, the first base station 831 may subsequently perform the operations corresponding to the base station Q described in FIG. 12. As another example, if the second base station 832 is configured as the base station Q and the second NTN link is determined to be the QuickLink, the second base station 832 831 may configure the second NTN link through itself as the QuickLink, and configure itself as the base station Q. In this case, if a base station corresponding to the previous QuickLink is the first base station 831, the first base station 831 may become a base station other than the base station Q.

In addition, if satellites operate as multiple TRPs as shown in FIG. 9, all satellites may be connected to one base station. Therefore, if satellites operate as multiple TRPs, step S1318 may be omitted.

Meanwhile, the operations described above, specifically steps S1316 and S1318, may be operations for transmitting information and configuring a base station Q when a new QuickLink is determined. Therefore, if there is no change in QuickLink based on the determination of step S1314, steps S1316 and S1318 may be omitted.

Step S1320 may be an operation performed when the base station Q configures the terminal to report (or update) latency information at a regular interval. Therefore, the base station Q may proceed to step S1310 when latency information is reported (or updated) periodically from the terminal.

If the terminal is not configured to report latency information periodically, the base station Q may proceed to step S1306. In addition, the case of proceeding to step S1306 may occur at a predetermine time interval, and when performing step S1306, step S1308 may also be performed.

The second exemplary embodiment described above has similar procedures to the first exemplary embodiment described above. In the first exemplary embodiment, location information of the terminal is used, but in the second exemplary embodiment, there is a difference in that a low latency link is discovered by collecting delay information for the respective links. The delay information described above may collectively refer to information for identifying a propagation delay of a wireless link. A representative example of the propagation delay may be a TA value. In the NTN, the TA value may include information as previously described in Equation 1. Therefore, when using the TA value, common delay information may refer to N_{TA,common} as described in Equation 1.

Before the terminal does not perform a random access procedure on an NTN link, the terminal may not know information on a delay (e.g. TA) occurring in a feeder link for the NTN link. Therefore, the terminal may not report information on the delay occurring in the feeder link of the corresponding NTN link to the base station before performing the random access procedure. Therefore, for the above-described case, the base station Q may receive information on the delay in the feeder link from the corresponding base station by performing steps S1308 and S1312.

Therefore, after the terminal performs a random access procedure for the corresponding NTN link, the terminal may know information on all delays (e.g. TAs) occurring in the service link and feeder link for the corresponding NTN link. Therefore, if the base station Q identifies whether the terminal has performed random access for the NTN link, it may determine whether to perform steps S1308 and S1312 for each base station. For example, if it is identified that all terminals have performed random access procedures for all NTN links, the base station Q may omit steps S1308 and S1312.

### Third Exemplary Embodiment: Low Latency Link Discovery Using Per-Link Delay Information

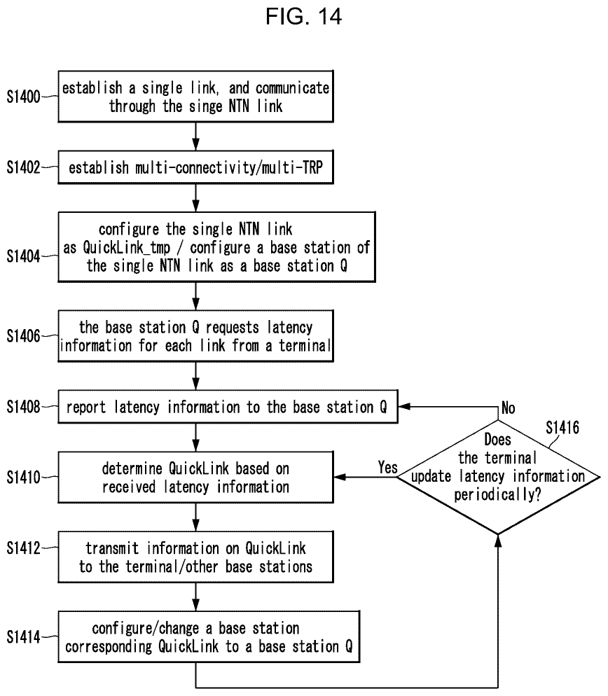

FIG. 14 is a flowchart of operations of an NTN according to a third exemplary embodiment of the present disclosure.

Hereinafter, the overall operations of the third exemplary embodiment of the present disclosure will be described with reference to FIG. 14.

In step S1400, the terminal and the base station may establish a single NTN link and communicate over the single NTN link. Since step S1400 is the same as step S1200 or step S1300 previously described in FIGS. 12 and 13, the same detailed description with reference to FIGS. 8 and 9 will be omitted.

In step S1402, the terminal may establish multi-connectivity or multi-TRP environment by connecting to at least one other satellite in addition to the single connected satellite. Since step S1402 is also the same as step S1202 or step S1302 previously described in FIGS. 12 and 13, the same detailed description with reference to FIGS. 8 and 9 will be omitted.

In step S1404, the base station may configure a single NTN link as a temporary QuickLink (i.e. QuickLink_tmp) and configure the base station as a base station Q. In the present disclosure, the base station Q may be a base station with a QuickLink. The base station Q may announce QuickLink_tmp to other nodes, for example, terminals and base stations, or terminals and satellites. If a QuickLink can be determined quickly, the base station Q may be configured not to announce QuickLink_tmp to other nodes.

Since step S1404 is also the same as step S1204 or step S1304 previously described in FIGS. 12 and 13, the same detailed description with reference to FIGS. 8 and 9 will be omitted.

In step S1406, the base station may request latency information for each NTN link from each of base stations establishing NTN links with the terminal. The third exemplary embodiment of the present disclosure describes methods for discovering a low latency link using the latency information. Therefore, the operation of step S1406 may correspond to a method of using latency information as low latency link-related information.

Describing step S1406 with reference to FIG. 8, the first base station 831 operating as the base station Q may request latency information of an NTN link through a satellite connected to each base station from the second base station 832 and/or the third base station 833. The first base station 831 may request latency information for each of the NTN links connected to the second base station 832 and/or the third base station 833 using a backhaul or Xn interfaces between the base stations.

In the case of FIG. 9 in which a plurality of satellites operate as multiple TRPs, the operation of step S1406 may not be performed because there is only one base station. That is, since the base station 931 knows a latency for each of the NTN links, there is no need to perform step S1406. Therefore, in the case of FIG. 9 in which a plurality of satellites operate as multiple TRPs, the base station Q may not perform step S1408, which will be described below.

In step S1408, other base stations may report latency information for NTN links connected with the terminal through themselves and satellites to the base station Q based on the latency information report request in step S1406.

As one of schemes for a base station to obtain a latency of a specific NTN link, a roundtrip time (RTT) may be measured. For example, the base station may transmit a signal for RTT measurement to the terminal through the specific NTN link and identify the latency of the specific NTN link using a signal returned from the terminal.

As another example of schemes for a base station to obtain a latency of a specific NTN link, a delay for a feeder link between a satellite and the base station (or gateway) may be calculated based on the altitude and location of the satellite. In addition, a delay for a service link may be calculated by using an average value for service links within a cell radius provided by the satellite at the altitude and location of the satellite. If the satellite is a bent-pipe satellite, the base station may receive information on a time required for the satellite to process a signal. Therefore, using a sum of these delays, the base station may calculate and obtain the latency toward the terminal connected through the satellite.

In the present disclosure, two schemes among various schemes for obtaining a latency of NTN link have been described. However, in the present disclosure, any other schemes for obtaining a latency of NTN link may be used in addition to the schemes described above. In other words, the present disclosure does not place any restrictions on how to obtain a latency of NTN link.

Using the schemes described above or other schemes, the base station may identify a latency of an NTN link connected to the corresponding terminal. Each base station may identify the latency of the NTN link, and report information on the latency to the base station Q in step S1408. As described above, step S1408 may be applied in the case of multi-connectivity environment in which multiple satellites are connected to the terminal through the respective base stations, as shown in FIG. 8. In other words, if satellites operate as multiple TRPs as shown in FIG. 9, step S1408 may be omitted.

In step S1410, since the base station Q receives latency information for each NTN link and information on a common delay for each base station from the terminal, the base station Q may determine a QuickLink based thereon. Given the latency information for the respective NTN links, the base station Q may identify which satellite link has low latency in several schemes. One of these schemes may use Equation 2 described above. Since Equation 2 has been described in the first exemplary embodiment, redundant description will be omitted.

In addition, in step S1410, in an environment where a plurality of satellites operate as multiple TRPs as shown in FIG. 9, the base station 931 may determine the QuickLink based on the latencies through the respective satellites.

In step S1412, the base station Q may transmit information on the determined QuickLink to the terminal and other base stations.

Describing step S1412 with reference to FIG. 8, the first base station 831 operating as the base station Q may transmit information on the determined QuickLink to the terminal 821 through the first NTN link, which is QuickLink_tmp. In addition, the first base station 831 operating as the base station Q may transmit information on the determined QuickLink to the second base station 832 and/or the third base station 833 using a backhaul or Xn interfaces connected between the base stations.

Describing step S1412 with reference to FIG. 9, the base station 931 may transmit information on the determined QuickLink to the terminal 921 through the first satellite 911 of the first NTN link, which is QuickLink_tmp. In the case of FIG. 9, since there are no other base stations, there is no need to transmit information on the determined QuickLink to other base stations.

QuickLink information transmitted in step S1412 may include the following two types of information.
(1) Information identifying a satellite for the newly designated QuickLink and/or a base station connected to the satellite: Through this information, terminals and base stations may identify which link is a QuickLink. In case of multi-TRP environment, since all links are connected to one base station, the terminal needs to be informed which link/satellite is the QuickLink.
(2) Application time for the newly designated QuickLink: In order to synchronize times when all base stations participating in the multiple links with the terminal apply the newly designated QuickLink, time information such as a frame number or sub-frame number, may be informed to synchronize application times of the QuickLink.

In step S1414, the terminal and base stations may configure the corresponding base station as the base station Q based on the QuickLink information.

Describing step S1414 with reference to FIG. 8, the first base station 831 may configure the QuickLink and the base station Q based on the QuickLink determined in step S1410. In addition, the second base station 832 and the third base station 833 may also configure the QuickLink and the base station Q based on the QuickLink determined in step S1410. Then, the terminal 821 may delete QuickLink_tmp, and configure the QuickLink based on the information received in step S1410. In other words, all base stations may identify the QuickLink and which base station is the base station Q.

For example, if the first base station 831 is configured as the base station Q and the first NTN link is determined to be the QuickLink, the first base station 831 may configure the first NTN link through itself as the QuickLink, and configure itself as the base station Q. Accordingly, the first base station 831 may subsequently perform the operations corresponding to the base station Q described in FIG. 12. As another example, if the second base station 832 is configured as the base station Q and the second NTN link is determined to be the QuickLink, the second base station 832 831 may configure the second NTN link through itself as the QuickLink, and configure itself as the base station Q. In this case, if a base station corresponding to the previous QuickLink is the first base station 831, the first base station 831 may become a base station other than the base station Q. In addition, if the base station corresponding to the previous QuickLink is the first base station 831, and a base station corresponding to the QuickLink determined in step S1410 is also the first base station 831, steps S1412 and S1414 may not be performed.

In addition, if satellites operate as multiple TRPs as shown in FIG. 9, all satellites may be connected to one base station. Therefore, if satellites operate as multiple TRPs, step S1414 may be omitted.

Step S1416 may be an operation performed when the base station Q configures the terminal to report (or update) latency information at a regular interval. Therefore, the base station Q may proceed to step S1410 when latency information is reported (or updated) periodically from the terminal.

If the terminal is not configured to report latency information periodically, the base station Q may proceed to step S1408. In addition, the case of proceeding to step S1408 may occur at a predetermine time interval.

The third exemplary embodiment described above has similar procedures to the second exemplary embodiment described above. In the third exemplary embodiment of the present disclosure, in order to collect TA information for each link of a terminal, delay information of the corresponding terminal may be requested from base stations participating in multi-connectivity with the terminal, and the QuickLink is configured through the information.

In step S1410, the base station of each link may know a delay of a feeder link regardless of whether the terminal has performed random access. However, if the terminal has not performed perform random access, a delay of a service link may not be identified. Therefore, the present disclosure may correspond to a terminal after performing random access. In other words, after the terminal performs a random access procedure, the base station can also know the delay of the service link. Therefore, if the terminal does not perform a random access procedure, the base station may use a value such as a maximum delay, minimum delay, and average delay time of service links within a coverage served by the satellite to replace the measured delay of the service link.

### Fourth Exemplary Embodiment: Low Latency Link Discovery Using the First to Third Exemplary Embodiments

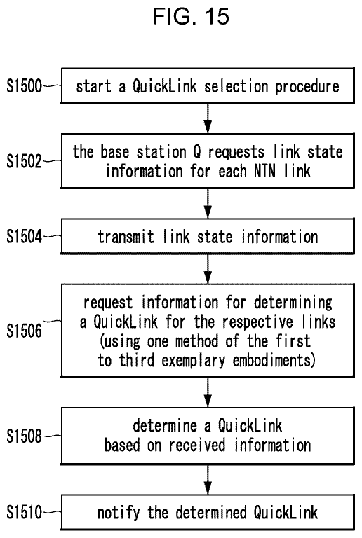

FIG. 15 is a flowchart of operations of an NTN according to a fourth exemplary embodiment of the present disclosure.

Step S1500 may correspond to a case when a QuickLink selection procedure starts. Step S1500 may correspond to steps S1200 to S1204 steps described in FIG. 12. In other words, step S1500 may be performed when the second satellite and/or third satellite is additionally connected to a specific terminal to establish a multi-connectivity or multi-TRP environment while a single NTN link is established and an NTN service is provided to the specific terminal. In addition, it may include a step where a specific base station, for example, a base station in a single NTN environment, is configured as a temporary base station Q.

In the above, step S1500 has been described using an example of FIG. 12, but those skilled in the art will know that it is also applicable to steps S1300 to S1304 of FIG. 13 or steps S1400 to S1404 of FIG. 14.

In step S1502, the base station Q may request NTN link state information for each NTN link from other base stations, for example, the second base station and/or the third base station. In the present disclosure, the NTN link state information may refer to information on whether a terminal (e.g. user equipment (UE)) has performed a random access procedure, whether the UE knows delay information (e.g. TA), whether the base station knows delay information of each link with the terminal, and/or how accurate location information of the terminal is.

In addition, since step S1502 is an operation to request NTN link state information from other base stations, it may only be performed in case of the multi-connectivity environment as previously described in FIG. 8. In other words, if satellites operate as multiple TRPs as shown in FIG. 9, step S1502 may be omitted.

In step S1504, other base stations may transmit NTN link state information to the base station Q based on the request of step S1502. Therefore, the base station Q may receive the NTN link state information from other base stations in step S1504.

In step S1506, the base station Q may request information for determining a QuickLink for the respective NTN links. Here, the procedure of requesting information for determining a QuickLink may be a procedure of obtaining low latency link-related information. The low latency link-related information may be the information described in the first to third exemplary embodiments above. Therefore, the information for determining a QuickLink for the respective NTN links may be obtained by applying the method of the first exemplary embodiment, the second exemplary embodiment, or the third exemplary embodiment.

When the first exemplary embodiment is applied, step S1506 may correspond to steps S1206 to S1210 and steps S1208 to S1212 described in FIG. 12. In other words, the low latency link-related information may be location information of nodes of the respective NTN links, which is described in the first exemplary embodiment.

When the second exemplary embodiment is applied, step S1506 may correspond to steps S1306 to S1310 and steps S1308 to S1312 described in FIG. 13. In other words, the low latency link-related information may be latency information for the respective NTN links, which is described in the second exemplary embodiment.

When the third exemplary embodiment is applied, step S1506 may correspond to steps S1406 to S1408 described in FIG. 14. In other words, the low latency link-related information may be latency information for the respective NTN links, which is described in the third exemplary embodiment.

In step S1508, the base station Q may determine a QuickLink based on information received for the respective NTN links. If the information is requested according to the scheme of FIG. 12 in step S1506, the method described in step S1214 may be used as a method for determining a QuickLink in step S1508. In addition, if the information is requested according to the scheme of FIG. 13 in step S1506, the method described in step S1314 may be used as a method for determining a QuickLink in step S1508. In addition, If the information is requested according to the scheme of FIG. 14 in step S1506, the method described in step S1410 may be used as a method for determining QuickLink in step S1508.

In step S1510, the base station Q may notify other base stations and terminals of the determined QuickLink. When the first exemplary embodiment of FIG. 12 is applied, the operation of step S1510 may correspond to steps S1216 and onward, such as steps S1216 and S1218. In addition, since notification to other base stations is limited to the multi-connectivity environment as shown in FIG. 8, QuickLink may be informed only to the terminal in the multi-TRP environment as shown in FIG. 9.

When the second exemplary embodiment of FIG. 13 is applied, the operation of step S1510 may correspond to steps S1316 and onward, such as steps S1316 and S1318. Also in the second exemplary embodiment, notification to other base stations is limited to the multi-connectivity environment as shown in FIG. 8, QuickLink may be informed only to the terminal in the multi-TRP environment as shown in FIG. 9.

When the third exemplary embodiment of FIG. 14 is applied, the operation of step S1510 may correspond to steps S1412 and onward, such as steps S1412 and S1416. Also in the third exemplary embodiment, notification to other base stations is limited to the multi-connectivity environment as shown in FIG. 8, QuickLink may be informed only to the terminal in the multi-TRP environment as shown in FIG. 9.

The operation of FIG. 15 described above may be performed repeatedly at a predetermined time interval because the each link state information may change.

Meanwhile, the methods for discovery a low latency link (QuickLink) have been described. The low latency link discovered as described above may be used in various fields. For example, the low latency link can be used when relatively urgent data needs to be transmitted, such as retransmission of data or transmission of important control messages.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first base station, comprising:
in response to a second non-terrestrial network (NTN) link being established with a terminal through a second satellite while a first NTN link is established with the terminal through a first satellite, configuring the first NTN link as a temporary low latency link;
obtaining first low latency link-related information for nodes of the first NTN link;
obtaining second low latency link-related information for nodes of the second NTN link;
determining a low latency link based on the first low latency link-related information and the second low latency link-related information; and
transmitting information on the determined low latency link to the terminal.

2. The method according to claim 1, wherein the nodes of the first NTN link include:
a first gateway directly connected to the first base station;
the first satellite connected to the first gateway through a first feeder link; and
the terminal connected to the first satellite through a first service link.

3. The method according to claim 2, wherein the nodes of the second NTN link include:
a second base station;
a second gateway directly connected to the second base station;
a second satellite connected to the second gateway through a second feeder link, and
the terminal connected to the second satellite through a second service link.

4. The method according to claim 3, further comprising: transmitting information on the low latency link to the second base station.

5. The method according to claim 3, further comprising:
requesting second NTN link state information from the second base station; and
receiving the second NTN link state information from the second base station,
wherein the second NTN link state information includes information on whether the terminal has performed a random access procedure.

6. The method according to claim 2, wherein the nodes of the second NTN link include:
the first gateway directly connected to the first base station;
a second satellite connected to the first gateway through a second feeder link, and
the terminal connected to the second satellite through a second service link.

7. The method according to claim 1, wherein the first low latency link-related information for the first NTN link includes at least one of location information of the nodes of the first NTN link or information on delays between the nodes of the first NTN link, and the second low latency link-related information for the second NTN link includes at least one of location information of the nodes of the second NTN link or information on delays between the nodes of the second NTN link.

8. The method according to claim 1, further comprising: re-determining the low latency link when periodic location or delay information is received from the terminal.

9. The method according to claim 1, wherein the determining of the low latency link comprises:
obtaining a first propagation delay of an NTN link having a minimum latency among NTN links that are not a current low latency link;
calculating a difference between a second propagation delay of the current low latency link and the first propagation delay; and
in response to the difference greater than a predetermined value, determining the NTN link having the first propagation delay as the low latency link.

10. A method of a first base station, comprising:
establishing a first non-terrestrial network (NTN) link with a terminal through a first satellite;
receiving a request for low latency link-related information from a second base station of a second NTN link already established with the terminal before establishing the first NTN link;
transmitting low latency link-related information of the first NTN link to the second base station according to the request;
in response to receiving information on a low latency link configured as an NTN link of the first base station from the second base station, obtaining low latency link-related information of all NTN links established with the terminal according to a preset time interval;
determining a low latency link based on the obtained low latency link-related information of all NTN links; and
transmitting information on the determined low latency link to the terminal.

11. The method according to claim 10, wherein the nodes of the first NTN link include:
a first gateway directly connected to the first base station;
a first satellite connected to the first gateway through a first feeder link; and
the terminal connected to the first satellite through a first service link.

12. The method according to claim 10, wherein the nodes of the second NTN link include:
a second base station;
a second gateway directly connected to the second base station;
a second satellite connected to the second gateway through a second feeder link, and
the terminal connected to the second satellite through a second service link.

13. The method according to claim 12, further comprising:
after establishing the first NTN link, receiving, from the second base station, a request for first NTN link state information including information on whether the terminal has performed a random access procedure; and
transmitting the first NTN link state information to the second base station according to the request.

14. The method according to claim 10, wherein the low latency link-related information for the first NTN link includes at least one of location information of the nodes of the first NTN link or information on delays between the nodes of the first NTN link, and the low latency link-related information for the second NTN link includes at least one of location information of the nodes of the second NTN link or information on delays between the nodes of the second NTN link.

15. The method according to claim 10, further comprising: re-determining the low latency link when periodic location or delay information is received from the terminal.

16. The method according to claim 10, wherein the determining of the low latency link comprises:
obtaining a propagation delay of an NTN link having a minimum latency among NTN links that are not a current low latency link;
calculating a difference between a propagation delay of the current low latency link and the propagation delay of the NTN link having the minimum delay; and
in response to the difference greater than a predetermined value, determining the NTN link having the minimum latency as the low latency link.

17. A first base station comprising a processor, wherein the processor causes the first base station to perform:
in response to a second non-terrestrial network (NTN) link being established with a terminal through a second satellite while a first NTN link is established with the terminal through a first satellite, configuring the first NTN link as a temporary low latency link;
obtaining first low latency link-related information for nodes of the first NTN link;
obtaining second low latency link-related information for nodes of the second NTN link;
determining a low latency link based on the first low latency link-related information and the second low latency link-related information; and
transmitting information on the determined low latency link to the terminal.

18. The first base station according to claim 17, wherein the processor further causes the first base station to perform: transmitting information on the low latency link to the second base station.

19. The first base station according to claim 17, wherein the processor further causes the first base station to perform:
requesting second NTN link state information from the second base station; and
receiving the second NTN link state information from the second base station,
wherein the second NTN link state information includes information on whether the terminal has performed a random access procedure.

20. The first base station according to claim 17, wherein the first low latency link-related information for the first NTN link includes at least one of location information of the nodes of the first NTN link or information on delays between the nodes of the first NTN link, and the second low latency link-related information for the second NTN link includes at least one of location information of the nodes of the second NTN link or information on delays between the nodes of the second NTN link.
